(19) United States
(12) Patent Application Publication
(10) Pub. No.: US 2025/0184067 A1
(43) Pub. Date: Jun. 5, 2025

(54) NETWORK ENERGY SAVINGS (NES) CELL COMMUNICATIONS

(71) Applicant: QUALCOMM Incorporated, San Diego, CA (US)

(72) Inventors: Navid ABEDINI, Basking Ridge, NJ (US); Jianghong LUO, Skillman, NJ (US); Tao LUO, San Diego, CA (US); Keerthi Priya DASALA, Bridgewater Township, NJ (US)

(21) Appl. No.: 18/527,193

(22) Filed: Dec. 1, 2023

(51) Int. Cl. H04L 5/00

(52) U.S. Cl. CPC H04L 5/005

(57) ABSTRACT

Aspects of the disclosure are directed to techniques for paging redirection to a cell configured for network energy saving (NES) and communication with a cell configured for NES. In certain aspects, a user equipment (UE) may be configured to receive, from an anchor cell, assist information indicating resources via which a cell configured for NES transmits a downlink reference signal (DL-RS). In certain aspects, the UE may receive, from the cell configured for NES, the DL-RS via the indicated resources.

### BACKGROUND

### Technical Field

The present disclosure generally relates to communication systems, and more particularly, to communications between a user equipment (UE) and a network comprising entities configured for network energy savings (NES).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors are configured to receive, from a first network entity, assist information indicating resources via which a second network entity transmits a downlink reference signal (DL-RS). In some examples, the one or more processors are configured to receive, from the second network entity, the DL-RS via the indicated resources.

Aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors are configured to transmit, to a user equipment (UE), assist information indicating resources via which a network entity transmits a downlink reference signal (DL-RS). In some examples, the one or more processors are configured to receive, from the UE, a report comprising information associated with the DL-RS collected by the UE.

Aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors are configured to transmit a first downlink reference signal (DL-RS) comprising at least one of a primary synchronization signal (PSS), a secondary synchronization signal (SSS), a channel state information reference signal (CSI-RS), or a tracking reference signal (TRS). In some examples, the one or more processors are configured to receive, from a network entity, signaling comprising information associated with the first DL-RS collected by a user equipment (UE).

Aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors are configured to receive, from a first network entity, a paging message indicating that a second network entity has downlink information to transmit to the apparatus. In some examples, the one or more processors are configured to receive, from one or more of the first network entity or the second network entity, assist information for establishing a connection to the second network entity. In some examples, the one or more processors are configured to transmit, to the second network entity, a random access channel (RACH) message after receiving the paging message and the assist information.

Aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors are configured to transmit, to a user equipment (UE), a paging message indicating that a network entity has downlink information to transmit to the UE. In some examples, the one or more processors are configured to transmit, to the UE, assist information to enable the UE to establish a connection to the network entity.

Aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors are configured to transmit, to a user equipment (UE), assist information to enable the UE to establish a connection to the apparatus, wherein the apparatus has downlink data to transmit to the UE. In some examples, the one or more processors are configured to receive, from the UE, initial access signaling for establishing a connection between the apparatus and the UE.

Aspects are directed to a method for wireless communication at a user equipment (UE). In some examples, the method includes receiving, from a first network entity, assist information indicating resources via which a second network entity transmits a downlink reference signal (DL-RS). In some examples, the method includes receiving, from the second network entity, the DL-RS via the indicated resources.

Aspects are directed to a method for wireless communication at an anchor cell. In some examples, the method includes transmitting, to a user equipment (UE), assist information indicating resources via which a network entity transmits a downlink reference signal (DL-RS). In some examples, the method includes receiving, from the UE, a report comprising information associated with the DL-RS collected by the UE.

Aspects are directed to a method for wireless communication at a network energy saving (NES) cell. In some examples, the method includes transmitting a first downlink reference signal (DL-RS) comprising at least one of a primary synchronization signal (PSS), a secondary synchronization signal (SSS), a channel state information reference signal (CSI-RS), or a tracking reference signal (TRS). In some examples, the method includes receiving, from a network entity, signaling comprising information associated with the first DL-RS collected by a user equipment (UE).

Aspects are directed to a method for wireless communication at a user equipment (UE). In some examples, the method includes receiving, from a first network entity, a paging message indicating that a second network entity has downlink information to transmit to the UE. In some examples, the method includes receiving, from one or more of the first network entity or the second network entity, assist information for establishing a connection to the second network entity. In some examples, the method includes transmitting, to the second network entity, a random access channel (RACH) message after receiving the paging message and the assist information.

Aspects are directed to a method for wireless communication at an anchor cell. In some examples, the method includes transmitting, to a user equipment (UE), a paging message indicating that a network entity has downlink information to transmit to the UE. In some examples, the method includes transmitting, to the UE, assist information to enable the UE to establish a connection to the network entity.

Aspects are directed to a method for wireless communication at a network energy saving (NES) cell. In some examples, the method includes transmitting, to a user equipment (UE), assist information to enable the UE to establish a connection to the NES cell, wherein the NES cell has downlink data to transmit to the UE. In some examples, the method includes receiving, from the UE, initial access signaling for establishing a connection between the NES cell and the UE.

Aspects are directed to an apparatus for wireless communication. In some examples, the apparatus includes means for receiving, from a first network entity, assist information indicating resources via which a second network entity transmits a downlink reference signal (DL-RS). In some examples, the apparatus includes means for receiving, from the second network entity, the DL-RS via the indicated resources.

Aspects are directed to an apparatus for wireless communication. In some examples, the apparatus includes means for transmitting, to a user equipment (UE), assist information indicating resources via which a network entity transmits a downlink reference signal (DL-RS). In some examples, the apparatus includes means for receiving, from the UE, a report comprising information associated with the DL-RS collected by the UE.

Aspects are directed to an apparatus for wireless communication. In some examples, the apparatus includes means for transmitting a first downlink reference signal (DL-RS) comprising at least one of a primary synchronization signal (PSS), a secondary synchronization signal (SSS), a channel state information reference signal (CSI-RS), or a tracking reference signal (TRS). In some examples, the apparatus includes means for receiving, from a network entity, signaling comprising information associated with the first DL-RS collected by a user equipment (UE).

Aspects are directed to an apparatus for wireless communication. In some examples, the apparatus includes means for receiving, from a first network entity, a paging message indicating that a second network entity has downlink information to transmit to the apparatus. In some examples, the apparatus includes means for includes receiving, from one or more of the first network entity or the second network entity, assist information for establishing a connection to the second network entity. In some examples, the apparatus includes means for transmitting, to the second network entity, a random access channel (RACH) message after receiving the paging message and the assist information.

Aspects are directed to an apparatus for wireless communication. In some examples, the apparatus includes means for transmitting, to a user equipment (UE), a paging message indicating that a network entity has downlink information to transmit to the UE. In some examples, the apparatus includes means for transmitting, to the UE, assist information to enable the UE to establish a connection to the network entity.

Aspects are directed to an apparatus for wireless communication at a network energy saving (NES) cell. In some examples, the apparatus includes means for transmitting, to a user equipment (UE), assist information to enable the UE to establish a connection to the NES cell, wherein the NES cell has downlink data to transmit to the UE. In some examples, the apparatus includes means for receiving, from the UE, initial access signaling for establishing a connection between the NES cell and the UE.

Aspects are directed to a non-transitory, computer-readable medium comprising computer executable code, the code when executed by one or more processors causes the one or more processors to, individually or in combination, perform operations comprising: receiving, from a first network entity, assist information indicating resources via which a second network entity transmits a downlink reference signal (DL-RS); and receiving, from the second network entity, the DL-RS via the indicated resources.

Aspects are directed to a non-transitory, computer-readable medium comprising computer executable code, the code when executed by one or more processors causes the one or more processors to, individually or in combination, perform operations comprising: transmitting, to a user equipment (UE), assist information indicating resources via which a network entity transmits a downlink reference signal (DL-RS); and receiving, from the UE, a report comprising information associated with the DL-RS collected by the UE.

Aspects are directed to a non-transitory, computer-readable medium comprising computer executable code, the code when executed by one or more processors causes the one or more processors to, individually or in combination, perform operations comprising: transmitting a first downlink reference signal (DL-RS) comprising at least one of a primary synchronization signal (PSS), a secondary synchronization signal (SSS), a channel state information reference signal (CSI-RS), or a tracking reference signal (TRS); and receiving, from a network entity, signaling comprising information associated with the first DL-RS collected by a user equipment (UE).

Aspects are directed to a non-transitory, computer-readable medium comprising computer executable code, the code when executed by one or more processors causes the one or more processors to, individually or in combination, perform operations comprising: receiving, from a first network entity, a paging message indicating that a second network entity has downlink information to transmit to the apparatus; receiving, from one or more of the first network entity or the second network entity, assist information for establishing a connection to the second network entity; and transmitting, to the second network entity, a random access channel (RACH) message after receiving the paging message and the assist information.

Aspects are directed to a non-transitory, computer-readable medium comprising computer executable code, the code when executed by one or more processors causes the one or more processors to, individually or in combination, perform operations comprising: transmitting, to a user equipment (UE), a paging message indicating that a network entity has downlink information to transmit to the UE; and transmitting, to the UE, assist information to enable the UE to establish a connection to the network entity.

Aspects are directed to a non-transitory, computer-readable medium comprising computer executable code, the code when executed by one or more processors causes the one or more processors to, individually or in combination, perform operations comprising: transmitting, to a user equipment (UE), assist information to enable the UE to establish a connection to the NES cell, wherein the NES cell has downlink data to transmit to the UE; and receiving, from the UE, initial access signaling for establishing a connection between the NES cell and the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a call-flow diagram illustrating example communications between a UE, an anchor cell, and an NES cell.

FIG. 6 is a call-flow diagram illustrating another example of communications between a UE, an anchor cell, and an NES cell.

FIG. 7 is a flowchart of a method of wireless communication.

FIG. 8 is a diagram illustrating an example of a hardware implementation for an example apparatus.

FIG. 9 is a flowchart of a method of wireless communication.

FIG. 10 is a diagram illustrating an example of a hardware implementation for an example apparatus.

FIG. 11 is a flowchart of a method of wireless communication.

FIG. 12 is a diagram illustrating an example of a hardware implementation for an example apparatus.

FIG. 13 is a flowchart of a method of wireless communication.

FIG. 14 is a diagram illustrating an example of a hardware implementation for an example apparatus.

FIG. 15 is a flowchart of a method of wireless communication.

FIG. 16 is a diagram illustrating an example of a hardware implementation for an example apparatus.

FIG. 17 is a flowchart of a method of wireless communication.

FIG. 18 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the disclosure are directed to enhancements for network energy savings (NES) in the context of wireless communications. NES relates to strategies or technologies aimed at reducing the energy consumption of a cellular network. In some examples, aspects of the disclosure relate to supporting light or on-demand synchronization signal blocks (SSBs) and/or system information blocks (SIBs). For example, a cell configured to function in an NES mode (e.g., referred to herein as an NES cell) may not always transmit a periodic SSB and/or system information, but rather the cell may transmit a lighter version of SSB and/or SIB, and/or send them whenever there is a demand.

The SSB and SIB are critical signals that a cell sends out periodically. The SSB, composed of the primary synchronization signal (PSS) and secondary synchronization signal (SSS), helps user equipment (UE), such as a mobile phone, to synchronize with the cell. The SIB carries system information that the UE may use to connect to the network. By sending a lighter or on-demand version of these signals, a cell could save energy, especially in low-traffic scenarios, thereby enhancing energy efficiency and sustainability for cellular networks.

In certain aspects, the lighter or on-demand signaling may be used and/or modified depending on the state of a UE, whether the NES cell is a serving cell, a secondary cell (SCell), or a neighboring cell, whether there is another cell (e.g., anchor cell, assisting cell, coverage cell, etc., as described below) that can facilitate detection of or connection to the NES cell, and how much of assistance can be provided. Thus, implementation could vary based on several factors: the state of the UE, the role of the NES cell, and the presence of an anchor cell. For example, whether the UE is idle or active may affect its ability to detect and connect to the NES cell. Specifically, an idle UE might periodically wake up to scan for signals, while an active UE might continuously monitor the radio environment. This state-dependent behavior is a key aspect of UE operation and may impact the energy consumption of both the UE and the network. In another example, the NES cell could be the serving cell (e.g., the cell that the UE is currently connected to), a secondary cell (e.g., an additional cell that the UE is connected to for extra bandwidth), or a neighboring cell (e.g., a cell that the UE is not currently connected to but could potentially connect to in the future). The role of the NES cell could affect how the UE interacts with it and how much energy the cell can save. In yet another example, the anchor cell is a cell that maintains a connection with the UE and can help facilitate a connection between the UE and the NES cell. The anchor cell may provide additional information that the NES cell doesn't provide, or it may relay signals between the UE and the NES cell. The amount of assistance provided could depend on the capabilities of the anchor cell and the specific requirements of the UE and NES cell.

The interaction between the UE, anchor cell, and NES cell could involve the UE detecting the NES cell with the help of the anchor cell, the UE requesting additional information from the anchor cell, and the UE establishing a connection with the NES cell.

In certain aspects, an NES cell may transmit a downlink reference signal (DL-RS) that is lighter than a legacy SSB (e.g., an SSB as described in Release 16 3GPP). For example, the DL-RS may include any combination of PSS, SSS, channel state information reference signal (CSI-RS), tracking reference signal (TRS), and/or any other suitable reference signal to facilitate detection and measurement of the DL-RS by a UE. However, the DL-RS carries less than all the information that is carried by the legacy SSB. For example, it may not provide full timing information or may not provide all of the signals carried by a legacy SSB.

Thus, the UE may search for an NES cell by trying to detect or measure the DL-RS. This involves scanning the radio spectrum to detect signals from nearby cells and measuring the strength and quality of received signals. These measurements help the UE determine which cell can provide the best connection. Upon detection of an NES cell via DL-RS, the UE may transmit a request and/or a report to an anchor/assisting cell in order to acquire more information about the NES cell. For example, the UE may detect the NES cell but may need more information to establish a connection. The anchor cell, which has an existing connection with the UE, may then provide the additional information needed. This could include more detailed timing information, configuration parameters, or other data that wasn't included in the light DL-RS signal. The anchor cell could also facilitate the connection to the NES cell by relaying signals between the UE and the NES cell. This way, the NES cell could save energy by transmitting a lighter signal, while the UE could still establish a connection by communicating with the anchor cell.

In certain aspects, a UE may first connect to an anchor cell, and if needed, be handed over to an NES cell via the anchor cell. However, to reduce latency, overhead, and power consumption for both the UE and the network, a faster connection to a candidate NES cell would be desirable. Thus, aspects of the disclosure are directed to paging redirection for the NES. For example, an idle/inactive UE may camp on an anchor cell. “Camping” in this context indicates that the UE monitors the cell's broadcast control channel and is ready to make or receive calls but is not actively communicating with the network. However, if the UE is paged (e.g., if there is downlink traffic for the UE), the UE may be allowed to initiate a connection to a NES cell directly. In some examples, “paging” may relate to a process where the network sends a message to the UE to notify it of incoming data. This mode of operation may allow for faster connections to NES cells, which could improve network performance and energy efficiency.

For example, in a legacy procedure (e.g., UE-to-NES cell connection procedure as described in Release 16 3GPP), if the UE detects an NES cell, it must first connect to an anchor cell (e.g., an FR1 macro cell). The anchor cell may then collect information from the UE to determine a candidate NES cell to serve the UE. The UE and the anchor cell may then perform a handover procedure to connect the UE to the NES cell. However, this legacy procedure may require a significant amount of time and signaling overhead to be accomplished. As such, by allowing a UE to camp on an anchor cell, the UE may be allowed to initiate connection to an NES cell directly (e.g., via RACH or otherwise) in response to being paged by the NES cell via the anchor cell.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

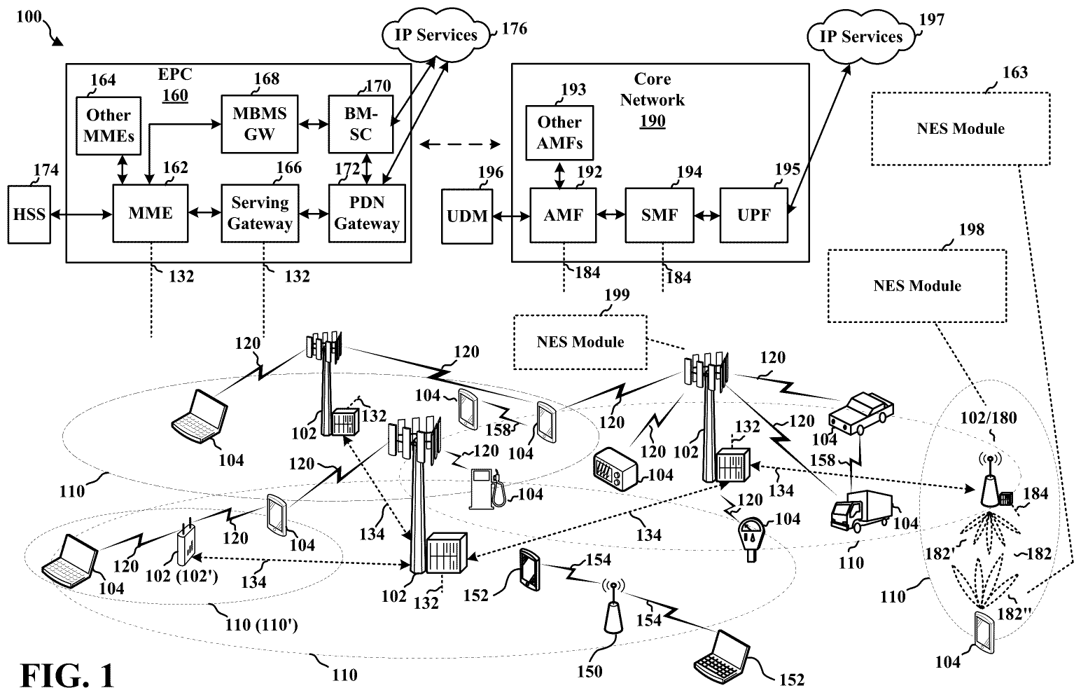

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity of the base station.

Referring again to FIG. 1, the UE 104 may include an NES module 163. As described in more detail elsewhere herein, the NES module 163 may be configured to receive, from a first network entity, assist information indicating resources via which a second network entity transmits a downlink reference signal (DL-RS); and receive, from the second network entity, the DL-RS via the indicated resources. In some examples, the NES module may be configured to receive, from a first network entity, a paging message indicating that a second network entity has downlink information to transmit to the apparatus; receive, from one or more of the first network entity or the second network entity, assist information for establishing a connection to the second network entity; and transmit, to the second network entity, a random access channel (RACH) message after receiving the paging message and the assist information. Additionally, or alternatively, the NES module 198 may perform one or more other operations described herein.

Referring again to FIG. 1, an anchor node 102/180 may include an NES module 198. As described in more detail elsewhere herein, the NES module 198 may be configured to transmit, to a user equipment (UE), assist information indicating resources via which a network entity transmits a downlink reference signal (DL-RS); and receive, from the UE, a report comprising information associated with the DL-RS collected by the UE. In some examples, the NES module 198 may be configured to transmit, to a user equipment (UE), a paging message indicating that a network entity has downlink information to transmit to the UE; and transmit, to the UE, assist information to enable the UE to establish a connection to the network entity. Additionally, or alternatively, the NES module 198 may perform one or more other operations described herein.

A network energy saving (NES) cell (e.g., base station 102) may include an NES module 199. As described in more detail elsewhere herein, the NES module 199 may be configured to transmit a first downlink reference signal (DL-RS) comprising at least one of a primary synchronization signal (PSS), a secondary synchronization signal (SSS), a channel state information reference signal (CSI-RS), or a tracking reference signal (TRS); and receive, from a network entity, signaling comprising information associated with the first DL-RS collected by a user equipment (UE). In some examples, the NES module 199 may be configured to transmit, to a user equipment (UE), assist information to enable the UE to establish a connection to the apparatus, wherein the apparatus has downlink data to transmit to the UE; and receive, from the UE, initial access signaling for establishing a connection between the apparatus and the UE. Additionally, or alternatively, the NES module 199 may perform one or more other operations described herein.

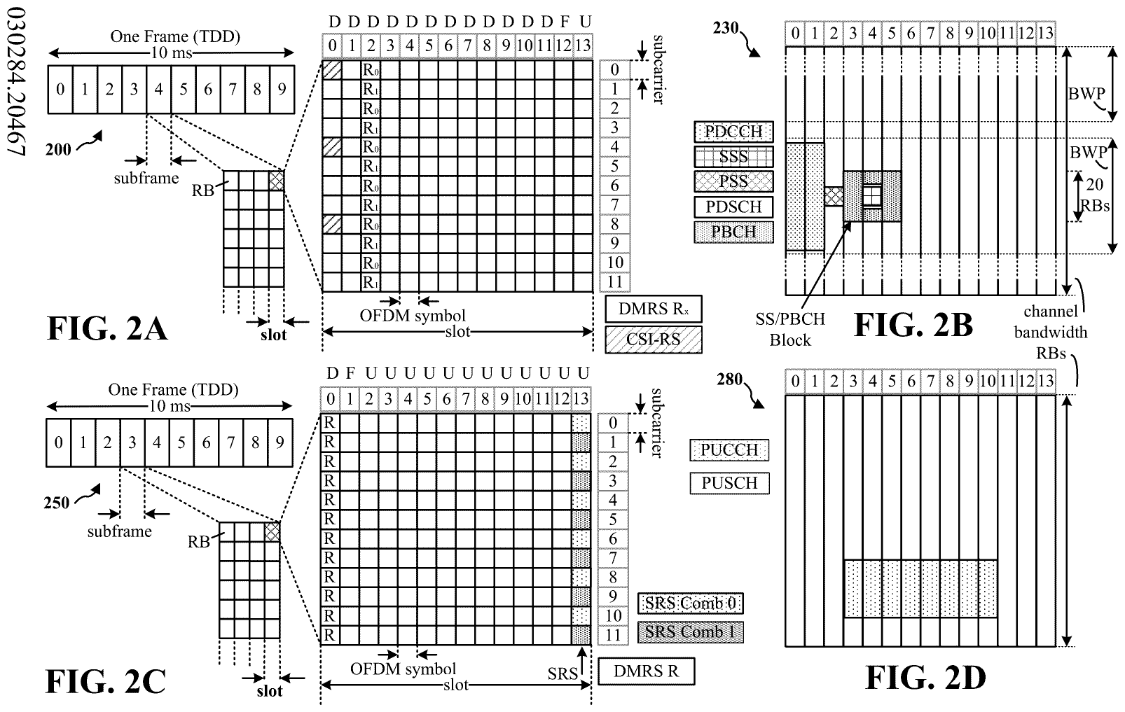

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

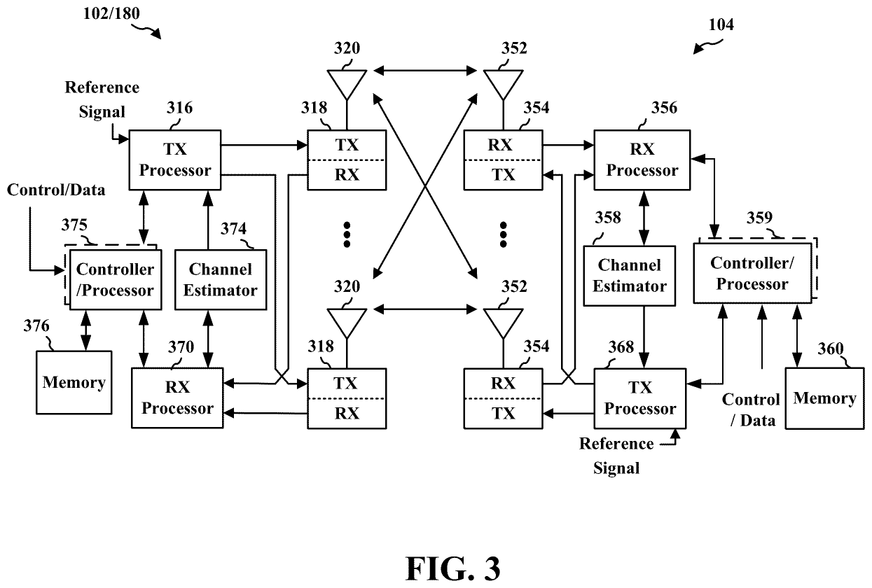

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the NES module 163 of FIG. 1.

At least one of the TX processor 316, the RX processor 370, and the controller/processor 375 may be configured to perform aspects in connection with the NES modules 198 and 199 of FIG. 1.

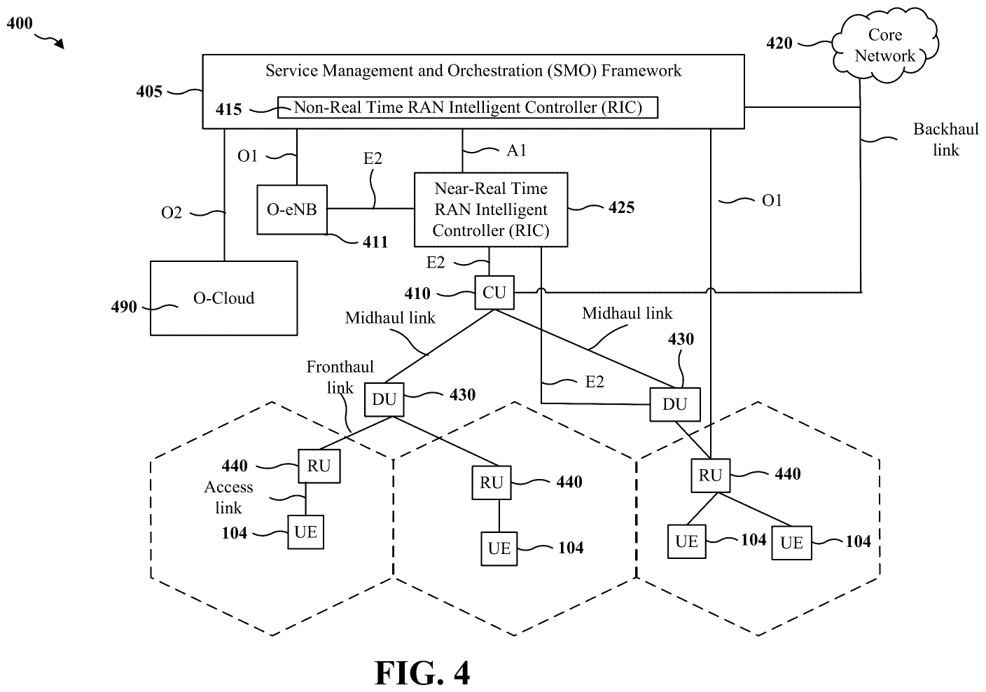

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Introduction to Network Energy Saving (NES) Aspects

In the context of cellular communication, “initial access” refers to the process by which a user equipment (UE) (e.g., a smartphone, tablet, or other suitable device) establishes a connection with a cellular network for the first time or re-establishes a connection after being out of coverage. The initial access procedure enables communication between the UE and the cellular network.

An initial access procedure may include one or more of: synchronization (e.g., where the UE synchronizes with the network's timing and frequency to ensure that the UE and network are operating on the same time and radio frequency), random access channel (RACH) communications (e.g., where the UE, after identifying a target cell, initiates a random access procedure to request access to the network), and a network response (e.g., where the network receives the random access preamble, acknowledges the request, and assigns resources for communications between the UE and the cell).

In some examples, a cell may be configured to periodically broadcast signals to allow the UE to perform the initial access process. Such signals may include synchronous signals (e.g., SSB, MIB, SIB, etc.). The cell may also be configured to receive RACH preamble signaling from the UE via certain resources indicated by the broadcast signals.

However, from the network's perspective, such signaling and resource allocation for receiving initial access signals from UEs may consume a significant amount of power. This is especially the case if relatively little initial access activity is expected. For example, a cell may perform little if any initial access functions at 3 AM because fewer UEs may attempt to connect with the cell compared to, for example, the number of UEs that attempt to connect with the cell at 5 PM. Similarly, certain cells located in remote or rural areas may not get as much initial access activity relative to cells located in urban areas. Thus, during certain time windows, within certain locations, or in any other suitable scenario, the network may benefit from reducing the amount of signals it transmits in support of initial access and/or reducing the amount of time the network spends monitoring for RACH signals. As used herein, such networks may be referred to as NES networks.

Accordingly, aspects of the disclosure are directed to techniques and apparatuses configured to reduce or eliminate certain initial access procedures to reduce power consumption by the network, while still allowing the UE to get access to the network.

### Examples of Communications Supporting NES Networks

Aspects of the disclosure relate to an NES network (e.g., a target cell) configured to transmit a downlink reference signal (DL-RS) that is “lighter” compared to an SSB broadcast. For example, the DL-RS may include fewer signals relative to the SSB and may therefore reduce power used by the NES network to transmit such signaling. The DL-RS signaling may be used by a UE to perform initial access procedures as described in more detail below. The DL-RS signaling may not carry all of the information and signaling of an SSB, but may include one or more of a PSS, an SSS, a CSI-RS, and/or a TRS to facilitate detection and measurements (e.g., synchronization, channel estimation, and demodulation) by a UE.

Accordingly, an NES cell may periodically transmit the DL-RS and a UE may search for the NES cell by scanning the radio spectrum to detect the DL-RS. Once the UE detects the DL-RS, the UE may transmit a request and/or report to an anchor/assisting cell in order to acquire additional information (e.g., information not present in the DL-RS that would otherwise be included in an SSB) about the NES cell in order to perform initial access. As discussed, an anchor cell may facilitate a connection between a UE and an NES cell. In some examples, the anchor cell may provide additional information to the UE that the NES cell does not provide to the UE. In some examples, the anchor cell may relay signaling between the UE and the NES cell. The amount of assistance that the anchor cell provides may depend on the capabilities of the anchor cell and the UE, and/or the specific requirements of the UE and NES cell.

In response, the anchor cell may provide the additional information to the UE. For example, if the UE detects the NES cell via the DL-RS, but needs more information to establish a connection, the UE may transmit a request to the anchor cell. The anchor cell may transmit the additional information to the UE, which may include timing information, configuration parameters, or other data that wasn't included in the lighter DL-RS signal. Thus, in some examples, the anchor cell may facilitate the connection to the NES cell by relaying signals between the UE and the NES cell. This way, the NES cell could save energy by transmitting a lighter signal, while the UE could still establish a connection by communicating with the anchor cell.

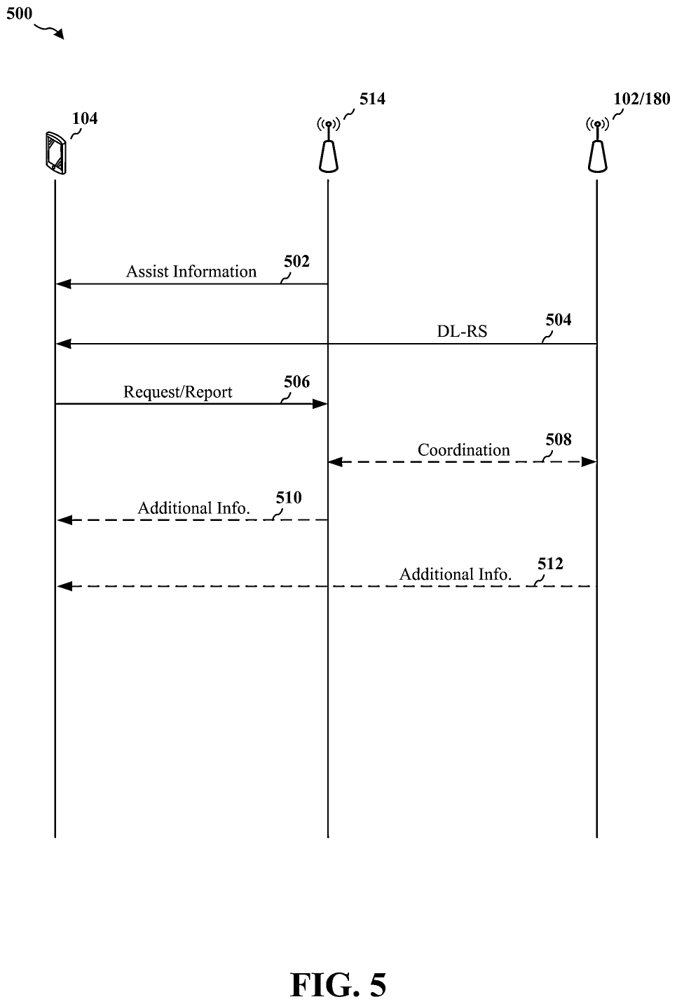

FIG. 5 is a call-flow diagram illustrating example communications between a UE 104 (e.g. UE 104 of FIGS. 1 and 3), an anchor cell 514 (e.g., a macro base station 102 of FIGS. 1 and 3), and an NES cell 102 (e.g., base station 102/180 of FIGS. 1 and 3).

At a first communication 502, the anchor cell 514 may transmit assist information to the UE 104. The assist information may be broadcast (e.g., sent to all UE(s) in the cell) or unicast (sent to a specific UE). The information may be included in a system information (SI) message, which is a type of message that a cell sends to provide UEs with necessary system-related information. The method of transmission (e.g., broadcast or unicast) and the timing (e.g., always sent or on-demand) may depend on the state of the UE. For example, whether the UE 104 is in a connected state (e.g., actively communicating with the anchor cell 514 and/or NES cell 102) or an idle/inactive state (e.g., not actively communicating, but ready to move to the connected state when necessary).

The assist information may include details about the time, frequency, and/or spatial (beam-related) resources where the NES cell 102 transmits its DL-RS. It may also include part or all of the NES cell ID or the ID of its DL-RS. This information may help the UE 104 to more efficiently and accurately detect the NES cell 102, reducing the time and energy the UE 104 spends on the detection process.

The assist information may be broadcast (e.g., sent to all UE(s) in the cell) or unicast (sent to a specific UE). The information may be included in a system information (SI) message, which is a type of message that a cell sends to provide UEs with necessary system-related information. The method of transmission (e.g., broadcast or unicast) and the timing (e.g., always sent or on-demand) may depend on the state of the UE.

In some examples, whether the UE 104 receives the assist information of the first communication 702 may depend on whether the UE 104 is in a connected state (e.g., actively communicating with the anchor cell 514 and/or NES cell 102) or an idle/inactive state (e.g., not actively communicating, but ready to move to the connected state when necessary).

The assist information may include details about the time, frequency, and/or spatial (beam-related) resources where the NES cell transmits its DL-RS. It may also include part or all of the NES cell ID or the ID of its DL-RS. This information may help the UE 104 to more efficiently and accurately detect the NES cell 102, reducing the time and energy the UE spends on the detection process. In a second communication 504, the NES cell 102 may broadcast and the UE 104 may receive the DL-RS. In some examples, the UE 104 may receive the DL-RS based on the assist information.

At a third communication 506, and after receiving the DL-RS, the UE 104, which could be in either an idle/inactive or connected state, may transmit a request or report to the anchor cell 514. The specific method used to send this request/report may depend on the state of the UE 104. For example, if the UE 104 is an idle or inactive state, the UE 104 may transmit a request (e.g., a RACH message 1, RACH message 3, scheduling request (SR), PUCCH, PUSCH, and/or an uplink wake-up signal (UL-WUS), or any other suitable signaling, without establishing connection to the anchor cell 514) to the anchor cell 514 to trigger the anchor cell 514 to transmit the assist information. In some examples, the UE 104 may be preconfigured with set of resources over which it can send the request to the anchor cell 514 for the assist information. In response, the anchor cell 514 may transmit the assist information to the UE 104 via a unicast transmission, or via a broadcast transmission if there are multiple UEs in the cell. In this example, the UE 104 may not receive the assist information of the first communication 702 due to being in an idle or inactive state, but instead may receive a subsequent transmission of the assist information in response to the request. In another example, the anchor cell 514 may periodically broadcast the assist information so that all UEs in the cell may receive the information whether they are in an idle or connected state. Thus, the first communication 702 may be a periodic broadcast of the assist information. Thus, the manner in which the anchor cell 514 transmits the assist information may be based on the state of the UE 104.

In another example, if the UE 104 is in a connected state, the UE 104 may receive the assist information of the first communication 702 (either as a broadcast message or a unicast message in response to a request) and based on the assist information, receive the DL-RS from the NES cell 102. The UE 104 may transmit a report that includes information acquired from the received DL-RS. In some examples, the assist information may indicate types of measurements to include in the report and/or a configuration indicating the information to be included in the report. The report may be event-triggered (e.g., transmitted in response to a specific event, such as a paging from the anchor cell 514 indicating that the NES cell 102 has downlink information to transmit to the UE 104), dynamic (e.g., changing based on conditions that may be indicated in the assist information), and/or periodic (e.g., sent at regular intervals that may be indicated in the assist information). The UE 104 may transmit the report via a PUCCH and/or PUSCH. In some examples, the UE 104 may first transmit a scheduling request (e.g., an SR) to the anchor cell 514 to request a grant for PUSCH/PUCCH resources if not previously provided in the assist information.

As discussed, the anchor cell 514 may include a report configuration as part of the assist information, indicating the information and/or measurements that the UE 104 should include in its transmitted report. For example, the anchor cell 514 may configure the UE to include full or partial formation (e.g., ID of the NES cell 102, timing of the received DL-RS, frequency used by the NES cell 102 to transmit the received DL-RS, spatial/beam information associated with the received DL-RS, quality and/or strength of the received DL-RS, etc.) of the NES cell 102. However, depending on what information the UE 104 is able to collect based on the received DL-RS, the UE 104 may provide a full report or a partial report.

In some cases, the UE 104 may only have partial information about the NES cell if, for example, the DL-RS doesn't carry the full cell ID of the NES cell 102 or full timing of the NES cell 102 (e.g., in a scenario where the DL-RS comprises PSS but no SSS). Here, the UE may identify the NES cell 102 partially and/or the timing information of the NES cell 102 partially, and thus may only report this partial identification. In another example, if the DL-RS does not carry a full beam index (e.g., the DL-RS includes a part of the beam index but not the full beam index), the UE 104 may only report the partial beam index information it has acquired. In other words, if the DL-RS only includes part of the beam index (e.g., a unique identifier for less than all of the beams used by the NES cell 102), the UE may only report the partial beam index that it has acquired.

In another example, the report configuration may configure the UE 104 to provide partial information. Thus, even if the UE 104 acquires the full timing information, full beam index information, and/or full ID information of the NES cell 102 via the DL-RS, the UE 104 may transmit a report to the anchor cell 514 that includes less than all of the acquired information. Thus, the anchor cell 514 may reduce the overhead of the UE's report by limiting the information the UE 104 provides in the report. The anchor cell 514 may limit the information provided in the report based on several factors. For example, the anchor cell 514 may already have certain information about the NES cell 102 or may be configured to acquire the information via other means. In another example, based on the network deployment and the UE's location, there may be relatively few candidate NES cells around the UE. Here, the UE 104 may report an index associated with each candidate cell instead of the full NES cell ID of each candidate cell. It should be noted that the assist information may provide the UE 104 with a list of indices associated with each candidate NES cell within range of the anchor cell 514. Thus, the UE 104 may report an index associated with each candidate cell that the UE 104 detected. In another example, the UE 104 may report a portion of the detected candidate cell IDs instead of the full candidate cell IDs. For instance, the UE may be configured to report, for each candidate cell, one or more of: (i) the N least significant bits (LSBs) of the detected NES cell ID, (ii) the N most significant bits (MSBs) of the detected NES cell ID, and/or the PSS ID of the detected NES cell ID. In other words, the UE 104 may report a shortened version of a candidate NES cell ID(s) even if the UE 104 acquired full cell ID information from the candidate cells, which may be sufficient information for the anchor cell if there are relatively few candidate cells. In another example, the UE 104 may report an index to a frequency (e.g., raster frequency) associated with a candidate NES cell. Here, the assist information may provide the UE 104 with a list of indices associated with each candidate NES cell within range of the anchor cell 514.

In yet another example of a partial information report (whether based on a report configuration or based on limited information acquired by the UE 104 from the DL-RS), the UE 104 may provide information based on a level of synchronization of timing between the NES cell(s) and an anchor cell. Here, the UE 104 may report a minimum amount of information required to resolve any ambiguity of which NES cell is associated with the information the UE 104 is reporting. For example, the UE 104 may report a reference timing and/or a delta offset value may be reported. Here, the reference timing may include one or more of a beam-index, a symbol index, and/or a slot index of the anchor cell 514 or the NES cell 102, and the delta may be configured to characterize an offset between the transmission/reception timing of the anchor cell 514 and the NES cell 102. In other words, the UE could report a reference timing and a delta offset, which may provide sufficient information to resolve timing ambiguity between the NES cell 102 and the anchor cell 514.

In some examples, the UE 104 may be configured to report signal strength and/or signal quality information about the NES cell 102 to the anchor cell 514. Here, the UE 104 may report absolute values (e.g., a measured RSRP value and/or measured SINR value), threshold values, or relative values (e.g., an indication of a measured signal strength and/or quality of the DL-RS relative to a measured signal strength and/or quality of the anchor cell's 514 signaling) to the anchor cell 514. Thus, the UE 104 may report signal strength or quality of a candidate NES cell in different ways, depending on the report configuration and/or the capabilities of the UE.

It should be noted that in some examples, information that the UE 104 includes in the report may be beam specific. In an example scenario, part of the coverage of the NES cell 102 may be overlapping with the coverage of the anchor cell 514. Thus, part of the anchor cell 514 coverage may overlap with the coverage of NES cell 102, while some other part of the coverage of the anchor cell 514 may overlap with another NES cell 102. Accordingly, the anchor cell 514 may require more or different information for beams associated with the overlapping coverage between the anchor cell 514 and the NES cell 102, whereas the anchor cell 514 may require less or different information for beams associated with the overlapping coverage between the anchor cell 514 and the other NES cell. In this way, the anchor cell 514 may configure the UE 104 at a beam level based on overlapping coverage between the anchor cell 514 and one or more NES cells. In one example, the anchor cell 514 and/or the NES cell 102 may use multiple beams for transmission/reception. Here, the report configuration may configure the UE 104 to report a first set of information associated with a first beam of the NES cell 102 while reporting a second set of information associated with a second beam of the NES cell 102. Similarly, the report configuration may configure the UE 104 to report different information about the NES cell 102 to the anchor cell 514 depending on which anchor cell 514 beams the UE 104 uses to communicate the report. It should be noted that a beam refers to a specific direction of signal transmission, and different beams could have different characteristics and requirements. This flexibility allows the UE 104 to interact with multiple parts of the network simultaneously, which could improve network performance and efficiency.

In some examples, the report configuration may configure the UE 104 to transmit a report for each beam of the NES cell 102 for which the UE 104 receives a DL-RS, or a single report for multiple beams associated with the NES cell 102. In some examples, the report configuration may configure the UE 104 to transmit a report for each candidate NES cell from which the UE 104 receives a DL-RS, or a single report for multiple NES cells. In some examples, the report configuration may configure the UE 104 with a maximum number of candidate NES cells and/or a maximum number of beams associated with each NES cell.

At an optional fourth communication 508, the anchor cell 514 and the NES cell 102 may share information and coordinate as to whether the NES cell 102 will allow the UE 104 access to the NES cell 102.

Here, the anchor cell 514 may share all or a portion of the information acquired from the UE report with the candidate NES cell(s). This sharing of information may provide the candidate NES cell(s) with an enhanced awareness of the UE's needs in terms of wireless communication and current network conditions, which may improve the efficiency and performance of the network. For example, in response to the information shared by the anchor cell 514, the NES cell 102 may send additional information to the UE. In this example, and in response to receiving the UE-reported information from the anchor cell 514, the NES cell 102 may transmit one or more of: a full SSB (note that the NES cell 102 may have only transmitted the DL-RS in lieu of the SSB up until receiving the UE-reported information from the anchor cell 514), additional information not included in the DL-RS, and/or MIB and/or SIB information. In some examples, in response to receiving the UE-reported information from the anchor cell 514, the NES cell 102 may begin monitoring for any uplink requests from the UE 104, including RACH transmissions from the UE 104.

In some examples, in response to receiving the UE-reported information from the anchor cell 514, the NES cell 102 may transmit information to the anchor cell 514, which the anchor cell may then transmit to the UE 104 via an optional fifth communication 510. Here, the NES cell 102 may notify the anchor cell 514 whether the NES cell 102 is willing to become more active with signaling (e.g., as discussed above) and/or accept a connection from the UE 104. The NES cell 102 may also provide the anchor cell 514 with additional information regarding resources and/or configurations to be shared with the UE 104 via a fifth communication 510. In some examples, the NES cell 102 may direct the anchor cell 514 to provide the additional information to the UE 104 so that the UE 104 may perform additional communications and/or measurements using the resources and/or configurations. The NES cell 102 may also request that the anchor node provide additional timing information based on what was shared by the UE 104 in the report.

In an optional sixth communication, the NES cell 102 may transmit one or more of: the full SSB, the additional information not included in the DL-RS, and/or MIB and/or SIB information to the UE based on the information UE report information.

Accordingly, the anchor cell 514 may act as an intermediary for initial access communications between the UE 104 and the NES cell 102. This allows the NES cell 102 to maintain a low power state, by transmitting DL-RSs that consume less power than transmitting SSBs, MIBs, and/or SIBs. This also allows the NES cell 102 to reduce power consumption relating to the continuous monitoring of RACH resources.

### Examples of Paging Redirection

In certain aspects, some NES cells may provide minimal or no initial access service for the purpose of saving energy. In such a scenario, an anchor cell may perform aspects of initial access for UEs attempting to connect to such an NES cell. For example, a UE may initially establish a connection with an anchor cell prior to being handed over to an NES cell. However, to reduce latency, overhead, and power consumption for both the UE and the network, it would be desirable for a faster connection between a UE and a candidate NES cell. Thus, aspects of the disclosure relate to UEs (e.g., in an inactive state or idle state) to camp on an anchor cell. “Camping” in this context relates to a UE that monitors the anchor cell's broadcast control channel and is ready to make or receive calls but is not actively communicating with the network. If the UE is paged (e.g., if the UE receives an indication from the anchor cell's broadcast control channel that an NES cell has downlink traffic for the UE), the UE may be allowed to initiate a connection (e.g., perform an initial access process) to the NES cell directly. Paging is a process where the network sends a message to the UE to notify it of incoming data. This mode of operation could allow for faster connections to NES cells, which could enhance network performance and energy efficiency.

It should be noted that in some examples, an NES cell may be a fully active cell in some scenarios. For example, while the cell may be configured to operate in an energy saving mode, the cell may also be capable of operating outside of the energy saving mode. As such, an NES cell, in some cases, may transmit SSBs and monitor for initial access messaging via a RACH. This is in contrast to the examples above where the NES cell is transmitting DL-RSs instead of SSB in order to save power, and/or is not monitoring random access channels for initial access messaging. Accordingly, the types of signaling supported by a NES cell could vary depending on the cell's mode of operation (e.g., whether the cell is in full operation mode or energy saving mode.

In certain aspects, when a UE is in an idle or inactive state, the network may not have all information regarding the location of the UE. For example, the network may be aware that the UE is somewhere within a tracking region, but may not have enough information to know its exact location within that region. Thus, when the UE needs to be paged, multiple different cells within the region may transmit a paging message for the UE. When multiple different cells are paging the UE, the UE may determine that one or more of the multiple cells have a relatively better signal strength or quality. As such, the UE may prefer to establish a connection with these one or more cells over other cells in the region, and these preferred cells may be NES cells that are not operating in an energy saving mode. Thus, in certain aspects, the network may allow the UE to select a preferred cell and redirect the UE from a cell whose signal is relatively weak to the preferred cell for its connection even if the preferred cell isn't configured as an NES cell or if the preferred cell is not operating in an energy saving mode. Thus, the UE may be allowed to initiate connection with the preferred NES cell directly despite the preferred cell not operating in an energy saving mode. By allowing the UE to select and redirect to a preferred target cell may enhance network efficiency by directing the UE to the best cell for its connection.

In some examples, the UE-preferred cell or target cell may be a NES cell configured to limit access to only certain UEs. Thus, even if the NES cell is not operating in a power saving mode, the NES cell may still limit the number or types of UEs that can establish a connection to it. In some examples, the NES cell may broadcast such limitations, such as, only UEs with an NES capability may initiate access to the NES cell. Thus, if the UE is a legacy UE without an NES capability, and the UE-preferred cell is an NES cell that limits access to NES-capable UEs, the legacy UE may be forced to establish connection with a cell having a relatively lower quality signal. In other words, the limiting NES cell may selectively allow connections with UEs that are capable of supporting energy-saving operations. However, in certain aspects, if the limiting NES cell is a preferred cell and it is paging the UE, then the UE may be allowed to establish a connection to the limiting cell despite being a legacy UE. For example, when a UE is paged and redirected to the NES cell by an anchor cell, the NES cell may be notified (e.g., via backhaul signaling from its CU, a neighboring CU, or by AMF) to make an exception for the legacy UE.

In some examples, a preferred NES cell may not support transmission of paging messages. For example, the NES cell may be in a power saving mode and may not support paging operations while in that mode. Accordingly, an anchor cell may perform paging operations for the NES cell. In some cases, the NES cell may broadcast (e.g., via MIB and/or SIB) that it does not currently support paging. However, the surrounding network (e.g., adjacent cells) may be affected if one or more NES cells are not paging. As such, information about which cells are not paging may be exchanged within the network in order to manage which cells are paging and which are not. Thus, in some examples, this information may be exchanged between network entities via backhaul interfaces. For example, the information may be exchanged between CUs via Xn, the information may be exchanged between a CU and an AMF via a next generation application protocol (NGAP). By exchanging this information, the AMF may learn that a particular cell is active but does not support paging, and therefore, the AMF may provide paging messages to only those cells that support paging. In other words, the exchange of information within the network infrastructure may notify various entities aware of the cell's mode of operation and take it into account when managing network connections. However, in some scenarios, the AMF and/or CU may request that the cell begin supporting paging if the UE needs to be paged by that cell. For example, the paging may be indicative of a high priority message, or the UE may be a high priority device, and locating the UE may thus be a high priority. Accordingly, the network may dynamically adjust the a cell's capabilities based on the current network conditions and requirements.

In some examples, a preferred NES cell may not support RACH monitoring. For example, the NES cell may be in a power saving mode where the cell no longer monitors RACH for initial access messages from UEs. Thus, although RACH resources may be configured for the cell, it may not monitor those resources when in a power saving mode. In some cases, the cell may broadcast (e.g., via SI by the cell and/or via SI or dedicated RRC from the anchor cell) that it is not monitoring its configured RACH resources. Accordingly, if the anchor cell pages the UE, then the UE may typically try to initiate connection to a cell by, for example, transmitting a RACH Message 1 to the cell using the RACH resources. However, if the UE-preferred cell is not monitoring RACH, the UE may not perform initial access with the cell. Thus, in certain aspects of the disclosure, the UE-preferred cell may make an exception and may monitor for RACH over the configured resources if the cell knows that a UE in the vicinity of the cell is being paged. In one example, the anchor cell may page the UE and include information in the page indicating that the UE is authorized to perform initial access with the UE-preferred NES cell. In this example, the preferred cell may temporarily monitor the configured RACH resources in order to enable the UE to directly establish a connection with the preferred cell. In certain aspects, when a UE is paged and redirected to the NES cell by an anchor cell, the NES cell may be notified (e.g., via backhaul signaling from its CU, a neighboring CU, or by AMF) to start monitoring for RACH.

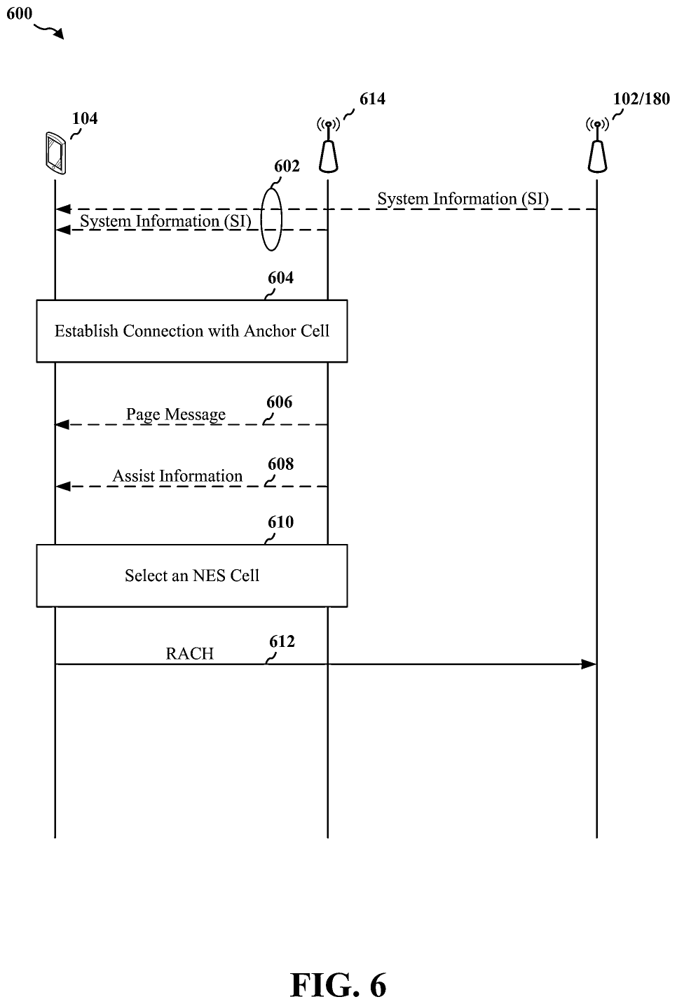

In certain aspects, a preferred NES cell may not broadcast SI, or may only send SI on demand (e.g., when a UE is trying to connect to the network), as part of an energy saving mode. Here, the anchor cell may transmit SI for the NES cell which means that the anchor cell may provide the UE with the necessary system-related information for the preferred NES cell. However, in some examples, the SI may be transmitted by the preferred NES cell. As illustrated in the first communication 602 of FIG. 6, one or more of the anchor cell 614 and the NES cell 102 may transmit (e.g., broadcast) SI. The SI may include assistance information for selection of anchor cells. For example, the SI may include a list of anchor cell IDs and/or frequencies that the UE can use for camping. In some examples, the SI may further indicate which anchor cells may support paging redirection to the UE-preferred NES cell. In other words, the SI may provide the UE with information about which anchor cells that may redirect the UE to the UE-preferred NES cell when there's downlink data available for the UE. The UE may select a particular anchor cell based on whether that anchor cell will redirect the UE to its preferred NES cell. In some examples, the list of anchor cells and/or frequencies may be beam-specific. That is, for different SSB indices of the NES cell, different candidate anchor cells may exist and be indicated. In other words, the SI may provide different information for different beams, and the UE may select a particular anchor cell based on a preferred beam of the UE-preferred NES cell. Further criteria for selection of anchor cells may be provided by the SI. This could involve various factors such as the quality of the anchor cell's signal, the signal strength, the requisite UE class and capabilities (e.g., limitations in terms of the UE capabilities or the type of UE traffic supported by an anchor cell), the supported Quality of Service (QOS), traffic types, etc. Thus, the SI may provide information to help the UE select the best anchor cell for its needs.

In certain aspects, a preferred NES cell may not transmit DL-RS as part of a power saving mode. As discussed, DL-RS may be used in cellular networks for synchronization, channel estimation, and/or demodulation. In some examples, DL-RS may include any of an SSB, a light-SSB (e.g., such as PSS-only, SSS-only, or PBCH-less SSB), a CSI-RS, a TRS, etc. These are different types of signals that the NES cell may transmit to provide the UE with necessary system-related information and to help the UE synchronize with the preferred NES cell. The transmission of these signals can be always-on and periodic, or on-demand. In other words, the NES cell may continuously send these signals at regular intervals, or it could send these signals only when there's a demand. In some examples, the demand for these signals may be directly made by the UE to the NES cell by transmitting a request to the preferred NES cell directly (e.g., in a form of UL-WUS or other suitable signaling). Alternatively, or in addition, the UE may transmit the request to the anchor cell, and/or the anchor cell may transmit the request to the NES cell. In response to such a request, the preferred NES cell switch from non-transmission of DL-RS to transmitting the DL-RS or any particular signal identified in the request. As such, the preferred NES cell may adjust its signal transmission based on requests from the UE or the anchor cell, which may enhance network efficiency and performance.

The above examples illustrate various signaling that may be supported by an NES cell, according to aspects of the disclosure. In several of the examples, the NES cell may not provide certain signaling, ignore monitoring for certain signaling, or otherwise prevent a UE from establishing a connection with the NES cell. However, in certain scenarios, for example, when a UE is paged and redirected to the preferred NES cell by an anchor cell, the NES cell may be notified (e.g., via backhaul signaling from its CU, a neighboring CU, or by AMF) to provide the signaling, monitor for signaling from the UE, or otherwise make an exception for the UE to allow the UE to initiate connection to the preferred NES cell directly via an initial access process.

FIG. 6 is a call-flow diagram illustrating example communications between a UE 104 (e.g. UE 104 of FIGS. 1 and 3), an anchor cell 614 (e.g., a macro base station 102 of FIGS. 1 and 3), and an NES cell 102 (e.g., base station 102/180 of FIGS. 1 and 3).

As discussed, the UE 104 may establish a connection with an anchor cell 614 (e.g., as illustrated in a first process 604) and camp on the anchor cell 614 until it receives a page from the anchor cell 614, at which point the UE 104 may attempt to connect with a preferred NES cell 102 directly to receive a downlink signal. In certain aspects, the anchor cell 614 may provide assist information to the camping UE 104 to assist the UE 104 establish a connection with a preferred NES cell 102 if the UE 104 is paged. Such assistance information may be broadcast by the anchor cell 614 and/or the NES cell 102 in a first communication 602 and/or transmitted by the anchor cell 614 in a third communication 608. For instance, the assist information may provide a list of one or more NES cells that the UE 104 may establish a connection with. For example, if the UE 104 wants to send initial access messaging via RACH, the assist information may include which resources the UE 104 may send the RACH. If the UE 104 needs to acquire system information for an NES cell 102 before establishing connection, the assist information may provide the system information. In some examples, the anchor cell 614 may provide assist information that includes an indication of resources and/or configurations of candidate NES cells. This may include information regarding the candidate NES cell's signal strength, frequency, timing, etc., which may help the UE 104 select the best cell for its connection. The assist information may also provide configured grant-free access (CFRA) RACH resources and configuration to the UE 104 for one or more candidate NES cells. In some examples, CFRA is a method for the UE 104 to send data without having to request a grant from the NES cell 102. In another example, if a candidate NES cell 102 does not transmit DL-RS, the anchor cell 614 may provide assist information that includes an indication of transmission timing and/or transmission power for a RACH Message 1 to the UE 104. An indication of the anchor cell's timing, RSRP, and/or path loss may be used for such indications. For example, the UE 104 may use the anchor cell 614 signaling as a reference to determine NES cell timing. Here, the assist information may include an indication of an offset between anchor cell 614 signal timing and DL-RX timing of the NES cell 102, or an offset for estimated PL between the anchor cell 614 and the NES cell 102 to allow the UE 104 to set its transmission power for communications to the target NES cell 102. In some examples, the assist information may be in the form of SI (e.g., first communication 602) or dedicated RRC (e.g., third communication 608), and may indicate whether the anchor cell 614 supports redirecting the UE 104 to other NES cells, to which NES cells and/or frequencies the anchor cell 614 supports redirections, for which type and/or class of UEs, and/or for which type of traffic and/or QoS classes.

In certain aspects, the anchor cell 614 may provide the assist information to the UE in several ways. In one example, the assist information may be part of the extended paging message. For example, as illustrated in FIG. 6, the anchor cell 614 may transmit a paging message to the UE 104 in a second communication 606. Here, the anchor cell 614 may transmit a paging message to the UE 104 that includes the assist information in the same message. By including the indication in the paging message, the anchor cell 614 may efficiently provide the information to the UE 104. In another example, the anchor cell 614 may provide the assist information in a broadcast SI message (e.g., first communication 602). This may include the list of NES cells and some associated configuration information. By broadcasting this information, the anchor cell 614 may efficiently provide the information to all UEs in the cell. In another example, when the anchor cell 614 pages the UE 104, the page message may provide the UE 104 with an indication of whether it can select another target NES cell (e.g., from a list of NES cells), and/or the UE 104 may be provided with an index of one or multiple cells in the list provided in the SI. This may help the UE 104 to quickly and efficiently select a target NES cell 102 when it is paged. In some examples, the indication can be in any of a paging entity identifier (PEI) low-priority wake-up signal (LP-WUS)), paging PDCCH, paging PDSCH, or a lighter version of the paging message. In some examples, any part of the assist information may be provided in a separate PDCCH/PDSCH whose resource and/or configuration may be indicated in the paging PDCCH/PDSCH and/or in the SI. In other words, the anchor cell 614 may use multiple signals and channels to provide the UE 104 with assist information. In certain aspects, the UE 104 may use the anchor cell-provided assist information to select another NES cell or select the current NES cell 102 (e.g., during a first process 604) for which it is camped on an associated anchor cell 614 for establishing a connection. Alternatively, the provided info may be treated as a command from the network that the UE 104 is expected to follow. In this case, the UE 104 would be expected to select (e.g., during the first process 604) an NES cell indicated in the assist information for its connection. In some examples, when transmitting an uplink signal (e.g., RACH, illustrated at a fourth communication 612) to a target NES cell 102, the UE 104 may indicate its cause value. The cause value may indicate why the UE 104 is trying to connect to the NES cell 102, such as being paged by a particular anchor cell on which the UE 104 is not currently camped, being redirected by a particular anchor cell on which the UE 104 is not currently camped, or paged and/or redirected by the anchor cell 614 on which the UE 104 is currently camped. An indication of the cause value may be included in the RACH preamble, RACH Message 1 payload (in case of 2-step RACH), RACH Message 3, or a separate message. In another example, the UE 104 may share some information (e.g., channel measurements) with the anchor cell 614 upon which it is camped before establishing a full connection to the anchor cell 614. Based on the shared information, the anchor cell 614 may provide the UE 104 with assist information that includes a relatively more specific redirection command or recommendation. As such, the UE 104 may use the information to more efficiently establish a connection with a target NES cell 102.

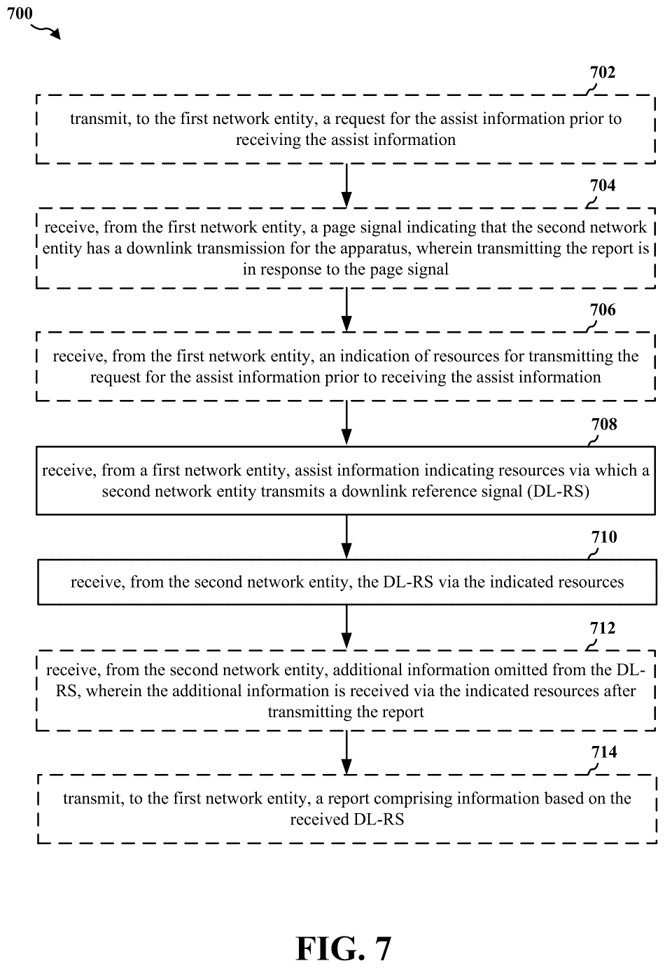

FIG. 7 is a flowchart 700 of a method of wireless communication. The method may be performed by a UE (e.g., the UE 104; the apparatus 802).

At 702, the UE may optionally transmit, to the first network entity, a request for the assist information prior to receiving the assist information. For example, 702 may be performed by a transmitting component 840.

At 704, the UE may optionally receive, from the first network entity, a page signal indicating that the second network entity has a downlink transmission for the UE, wherein transmitting the report is in response to the page signal. For example, 704 may be performed by a receiving component 842.

At 706, the UE may optionally receive, from the first network entity, an indication of resources for transmitting the request for the assist information prior to receiving the assist information. For example, 706 may be performed by the receiving component 842.

At 708, the UE may receive, from a first network entity, assist information indicating resources via which a second network entity transmits a downlink reference signal (DL-RS). For example, 708 may be performed by the receiving component 842.

At 710, the UE may receive, from the second network entity, the DL-RS via the indicated resources. For example, 710 may be performed by the receiving component 842.

At 712, the UE may optionally receive, from the second network entity, additional information omitted from the DL-RS, wherein the additional information is received via the indicated resources after transmitting the report. For example, 712 may be performed by the receiving component 842.

At 714, the UE may optionally transmit, to the first network entity, a report comprising information based on the received DL-RS. For example, 714 may be performed by the transmitting component 840.

In certain aspects, the DL-RS comprises at least one of a primary synchronization signal (PSS), a secondary synchronization signal (SSS), a channel state information reference signal (CSI-RS), or a tracking reference signal (TRS).

In certain aspects, the UE is in an idle state or an inactive state with respect to the first network entity, and wherein the request comprises a RACH transmission, a scheduling request (SR) transmission, a physical uplink control channel (PUCCH) transmission, a physical uplink shared channel (PUSCH) transmission, or an uplink wake-up signal (UL-WUS) transmission.

In certain aspects, the indicated resources comprise an indication of one or more of a time resource, a frequency resource, or spatial resource used by the second network entity to transmit the DL-RS.

In certain aspects, the assist information comprises a report configuration indicating information to be included in the report or a measurement to be included in the report, wherein the measurement is based on the received DL-RS.

In certain aspects, the report configuration further indicates one or more of: whether the UE is to include a full or partial identifier of the second network entity in the report, whether the UE is to include a full or partial beam index of the second network entity in the report, or whether the UE is to include full or partial timing information of the DL-RS received from the second network entity.

In certain aspects, if the UE is to include partial timing information of the DL-RS received from the second network entity, the report configuration further indicates that the UE is to include the partial timing information in terms of a reference timing, or a delta offset value.

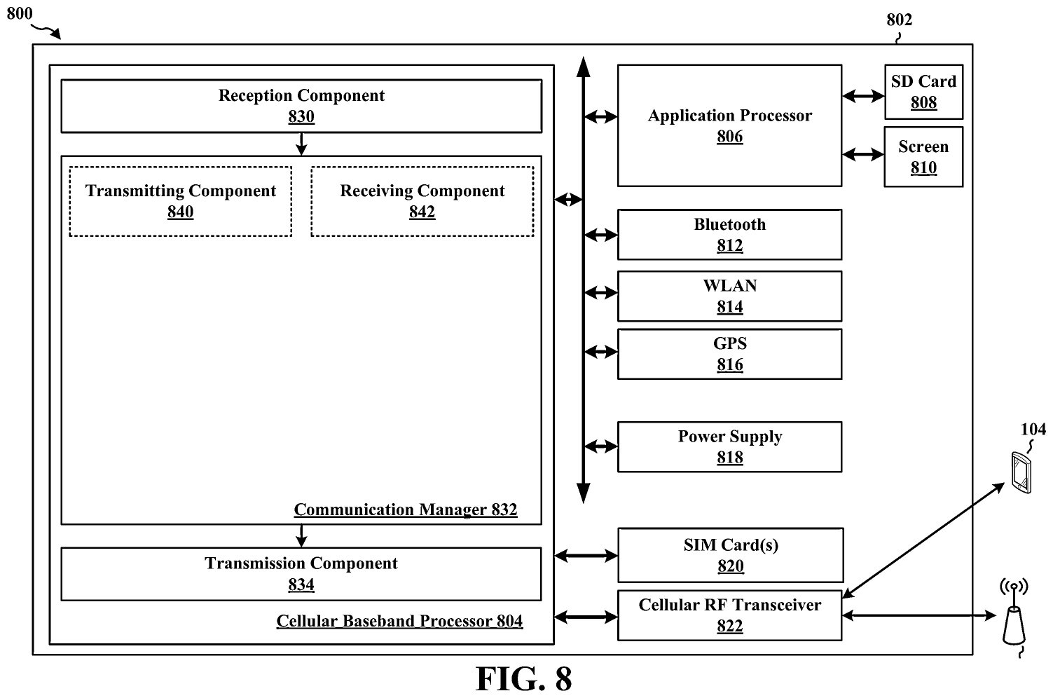

FIG. 8 is a diagram 800 illustrating an example of a hardware implementation for an apparatus 802. The apparatus 802 is a UE and includes a cellular baseband processor 804 (also referred to as a modem) coupled to a cellular RF transceiver 822 and one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, and a power supply 818. The cellular baseband processor 804 communicates through the cellular RF transceiver 822 with the UE 104 and/or BS 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 104 and may include the memory 360 and/or at least one of the TX processor 368, the RX processor 356, and the controller/processor 359. In one configuration, the apparatus 802 may be a modem chip and include just the baseband processor 804, and in another configuration, the apparatus 802 may be the entire UE (e.g., see UE 104 of FIG. 3) and include the aforediscussed additional modules of the apparatus 802.

In various examples, the apparatus 802 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 832 includes a transmitting component 840 configured to transmit, to the first network entity, a request for the assist information prior to receiving the assist information; and transmit, to the first network entity, a report comprising information based on the received DL-RS; e.g., as described in connection with 702 and 714 of FIG. 7.

The communication manager 832 further includes a receiving component 842 configured to receive, from the first network entity, a page signal indicating that the second network entity has a downlink transmission for the apparatus, wherein transmitting the report is in response to the page signal; receive, from the first network entity, an indication of resources for transmitting the request for the assist information prior to receiving the assist information; receive, from a first network entity, assist information indicating resources via which a second network entity transmits a downlink reference signal (DL-RS); receive, from the second network entity, the DL-RS via the indicated resources; and receive, from the second network entity, additional information omitted from the DL-RS, wherein the additional information is received via the indicated resources after transmitting the report; e.g., as described in connection with 704, 706, 708, 710, and 712 of FIG. 7.

The apparatus may include additional components that perform each of the blocks of the algorithm in the aforementioned flowchart of FIG. 7. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 802, and in particular the cellular baseband processor 804, includes means for transmitting, to the first network entity, a request for the assist information prior to receiving the assist information; means for receiving, from the first network entity, a page signal indicating that the second network entity has a downlink transmission for the apparatus, wherein transmitting the report is in response to the page signal; means for receiving, from the first network entity, an indication of resources for transmitting the request for the assist information prior to receiving the assist information; means for receiving, from a first network entity, assist information indicating resources via which a second network entity transmits a downlink reference signal (DL-RS); means for receiving, from the second network entity, the DL-RS via the indicated resources; means for receiving, from the second network entity, additional information omitted from the DL-RS, wherein the additional information is received via the indicated resources after transmitting the report; and means for transmitting, to the first network entity, a report comprising information based on the received DL-RS.

The aforementioned means may be one or more of the aforementioned components of the apparatus 802 configured to perform the functions recited by the aforementioned means. As described supra, the apparatus 802 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

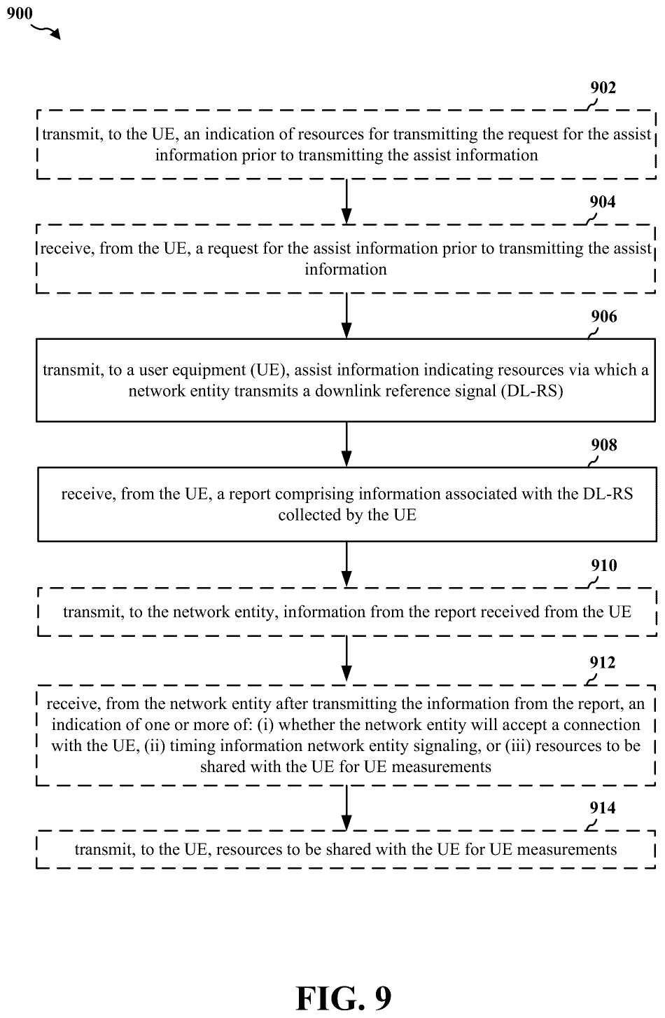

FIG. 9 is a flowchart 900 of a method of wireless communication. The method may be performed by a base station (e.g., the base station 102/180; the apparatus 902.

At 902, the base station may optionally transmit, to the UE, an indication of resources for transmitting the request for the assist information prior to transmitting the assist information. For example, 902 may be performed by a transmitting component 1040.

At 904, the base station may optionally receive, from the UE, a request for the assist information prior to transmitting the assist information. For example, 904 may be performed by a receiving component 1042.

At 906, the base station may transmit, to a user equipment (UE), assist information indicating resources via which a network entity transmits a downlink reference signal (DL-RS). For example, 906 may be performed by the transmitting component 1040.

At 908, the base station may receive, from the UE, a report comprising information associated with the DL-RS collected by the UE. For example, 908 may be performed by the receiving component 1042.

At 910, the base station may optionally transmit, to the network entity, information from the report received from the UE. For example, 910 may be performed by the transmitting component 1040.

At 912, the base station may optionally receive, from the network entity after transmitting the information from the report, an indication of one or more of: (i) whether the network entity will accept a connection with the UE, (ii) timing information network entity signaling, or (iii) resources to be shared with the UE for UE measurements. For example, 912 may be performed by the receiving component 1042.

At 914, the base station may optionally transmit, to the UE, resources to be shared with the UE for UE measurements. For example, 914 may be performed by the transmitting component 1040.

In certain aspects, the request comprises a RACH transmission, a scheduling request (SR) transmission, a physical uplink control channel (PUCCH) transmission, a physical uplink shared channel (PUSCH) transmission, or an uplink wake-up signal (UL-WUS) transmission.

In certain aspects, the indicated resources comprise an indication of one or more of a time resource, a frequency resource, or spatial resource used by the network entity to transmit the DL-RS.

In certain aspects, the assist information comprises a report configuration indicating information to be included in the report or a measurement to be included in the report, wherein the measurement is based on the received DL-RS.

In certain aspects, the assist information comprises a beam-specific report configuration identifying one or more beams associated with at least one of the apparatus or the network entity, and wherein the assist information further comprises an indication of a maximum number of beams for which the UE can include information in the beam-specific report.

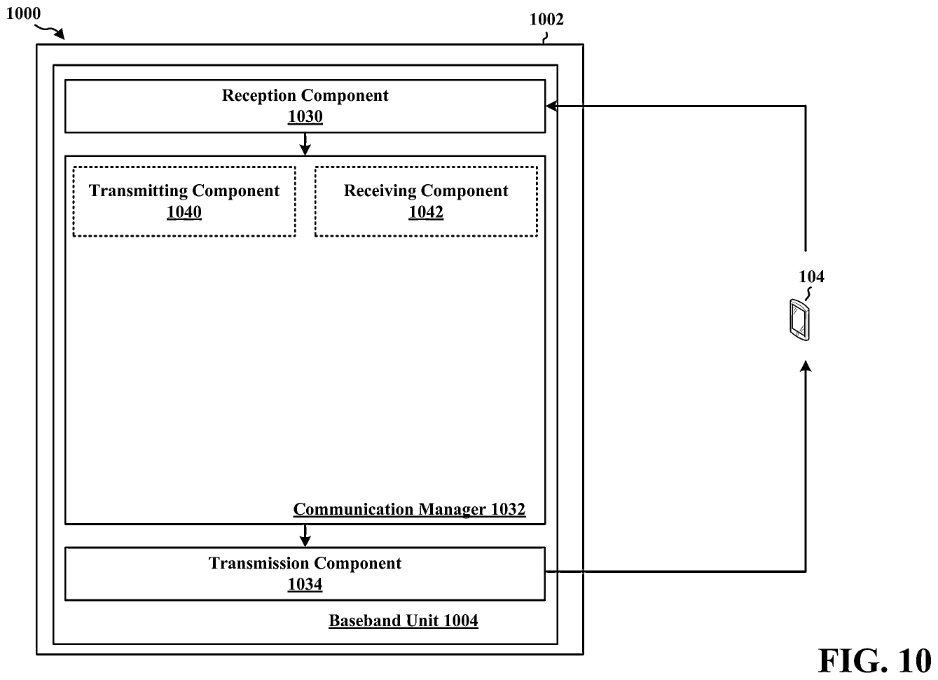

FIG. 10 is a diagram 1000 illustrating an example of a hardware implementation for an apparatus 1002. The apparatus 1002 is a BS and includes a baseband unit 1004. The baseband unit 1004 may communicate through a cellular RF transceiver with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the BS 102/180 and may include the memory 376 and/or at least one of the TX processor 316, the RX processor 370, and the controller/processor 375.

In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes a transmitting component 1040 configured to: transmit, to the UE, an indication of resources for transmitting the request for the assist information prior to transmitting the assist information; transmit, to a user equipment (UE), assist information indicating resources via which a network entity transmits a downlink reference signal (DL-RS); transmit, to the network entity, information from the report received from the UE; and transmit, to the UE, resources to be shared with the UE for UE measurements; e.g., as described in connection with 902, 906, 910, and 914.

The communication manager 1032 further includes a receiving component 1042 configured to: receive, from the UE, a request for the assist information prior to transmitting the assist information; receive, from the UE, a report comprising information associated with the DL-RS collected by the UE; and receive, from the network entity after transmitting the information from the report, an indication of one or more of: (i) whether the network entity will accept a connection with the UE, (ii) timing information network entity signaling, or (iii) resources to be shared with the UE for UE measurements; e.g., as described in connection with 904, 908, and 912.

The apparatus may include additional components that perform each of the blocks of the algorithm in the aforementioned flowchart of FIG. 9. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the baseband unit 1004, includes means for transmitting, to the UE, an indication of resources for transmitting the request for the assist information prior to transmitting the assist information; means for receiving, from the UE, a request for the assist information prior to transmitting the assist information; means for transmitting, to a user equipment (UE), assist information indicating resources via which a network entity transmits a downlink reference signal (DL-RS); means for receiving, from the UE, a report comprising information associated with the DL-RS collected by the UE; means for transmitting, to the network entity, information from the report received from the UE; means for receiving, from the network entity after transmitting the information from the report, an indication of one or more of: (i) whether the network entity will accept a connection with the UE, (ii) timing information network entity signaling, or (iii) resources to be shared with the UE for UE measurements; and means for transmitting, to the UE, resources to be shared with the UE for UE measurements.

The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

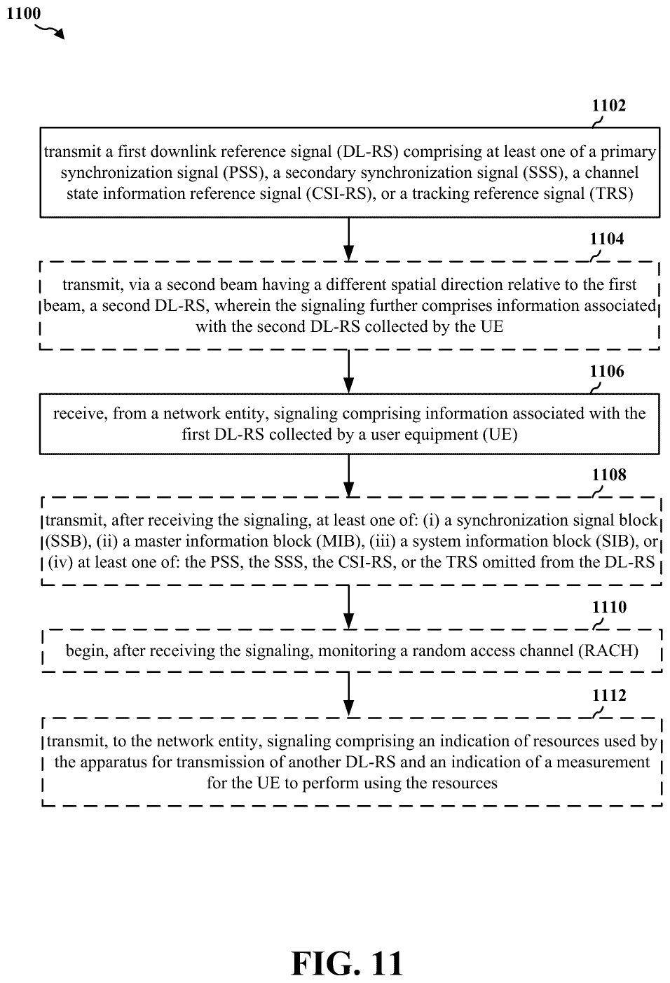

FIG. 11 is a flowchart 1100 of a method of wireless communication. The method may be performed by a base station (e.g., the base station 102/180; the apparatus 1202.

At 1102, the base station may transmit a first downlink reference signal (DL-RS) comprising at least one of a primary synchronization signal (PSS), a secondary synchronization signal (SSS), a channel state information reference signal (CSI-RS), or a tracking reference signal (TRS). For example, 1102 may be performed by a transmitting component 1240.

At 1104, the base station may optionally transmit, via a second beam having a different spatial direction relative to the first beam, a second DL-RS, wherein the signaling further comprises information associated with the second DL-RS collected by the UE. For example, 1104 may be performed by the transmitting component 1240.

At 1106, the base station may receive, from a network entity, signaling comprising information associated with the first DL-RS collected by a user equipment (UE). For example, 1106 may be performed by receiving component 1242.

At 1108, the base station may optionally transmit, after receiving the signaling, at least one of: (i) a synchronization signal block (SSB), (ii) a master information block (MIB), (iii) a system information block (SIB), or (iv) at least one of: the PSS, the SSS, the CSI-RS, or the TRS omitted from the DL-RS. For example, 1108 may be performed by the transmitting component 1240.

At 1110, the base station may optionally begin, after receiving the signaling, monitoring a random access channel (RACH). For example, 1110 may be performed by a monitoring component 1244.

At 1112, the base station may optionally transmit, to the network entity, signaling comprising an indication of resources used by the apparatus for transmission of another DL-RS and an indication of a measurement for the UE to perform using the resources. For example, 1112 may be performed by a transmitting component 1240.

In certain aspects, the information associated with the first DL-RS is first information if the apparatus is part of a same distributed unit (DU) or central unit (CU) as the network entity, wherein the information associated with the first DL-RS is second information if the apparatus is part of a different DU or CU as the network entity, and wherein the first information is different from the second information.

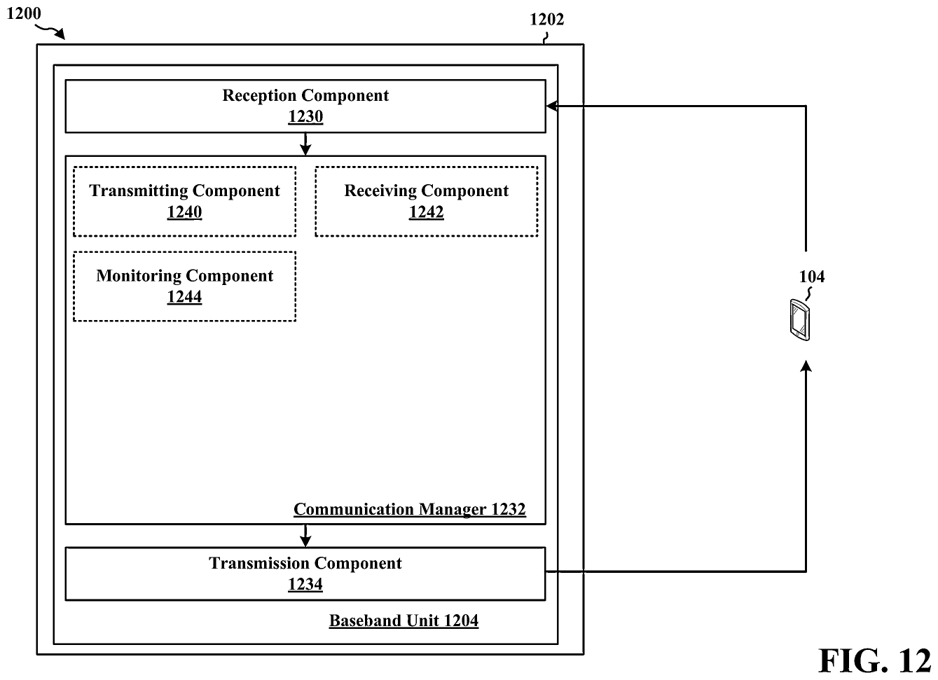

FIG. 12 is a diagram 1200 illustrating an example of a hardware implementation for an apparatus 1202. The apparatus 1202 is a BS and includes a baseband unit 1204. The baseband unit 1204 may communicate through a cellular RF transceiver with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the BS 102/180 and may include the memory 376 and/or at least one of the TX processor 316, the RX processor 370, and the controller/processor 375.

In various examples, the apparatus 1202 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1232 includes a transmitting component 1240 configured to: transmit a first downlink reference signal (DL-RS) comprising at least one of a primary synchronization signal (PSS), a secondary synchronization signal (SSS), a channel state information reference signal (CSI-RS), or a tracking reference signal (TRS); transmit, via a second beam having a different spatial direction relative to the first beam, a second DL-RS, wherein the signaling further comprises information associated with the second DL-RS collected by the UE; transmit, after receiving the signaling, at least one of: (i) a synchronization signal block (SSB), (ii) a master information block (MIB), (iii) a system information block (SIB), or (iv) at least one of: the PSS, the SSS, the CSI-RS, or the TRS omitted from the DL-RS; and transmit, to the network entity, signaling comprising an indication of resources used by the apparatus for transmission of another DL-RS and an indication of a measurement for the UE to perform using the resources; e.g., as described in connection with 1102, 1104, 1108, and 1112.

The communication manager 1232 further includes a receiving component 1242 configured to: receive, from a network entity, signaling comprising information associated with the first DL-RS collected by a user equipment (UE), e.g., as described in connection with 1106.

The communication manager 1232 further includes a monitoring component 1244 configured to: begin, after receiving the signaling, monitoring a random access channel (RACH), e.g., as described in connection with 1110.

The apparatus may include additional components that perform each of the blocks of the algorithm in the aforementioned flowchart of FIG. 11. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes means for transmitting a first downlink reference signal (DL-RS) comprising at least one of a primary synchronization signal (PSS), a secondary synchronization signal (SSS), a channel state information reference signal (CSI-RS), or a tracking reference signal (TRS); means for transmitting, via a second beam having a different spatial direction relative to the first beam, a second DL-RS, wherein the signaling further comprises information associated with the second DL-RS collected by the UE; means for receiving, from a network entity, signaling comprising information associated with the first DL-RS collected by a user equipment (UE); means for transmitting, after receiving the signaling, at least one of: (i) a synchronization signal block (SSB), (ii) a master information block (MIB), (iii) a system information block (SIB), or (iv) at least one of: the PSS, the SSS, the CSI-RS, or the TRS omitted from the DL-RS; means for beginning, after receiving the signaling, monitoring a random access channel (RACH); means for transmitting, to the network entity, signaling comprising an indication of resources used by the apparatus for transmission of another DL-RS and an indication of a measurement for the UE to perform using the resources.

The aforementioned means may be one or more of the aforementioned components of the apparatus 1202 configured to perform the functions recited by the aforementioned means. As described supra, the apparatus 1202 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

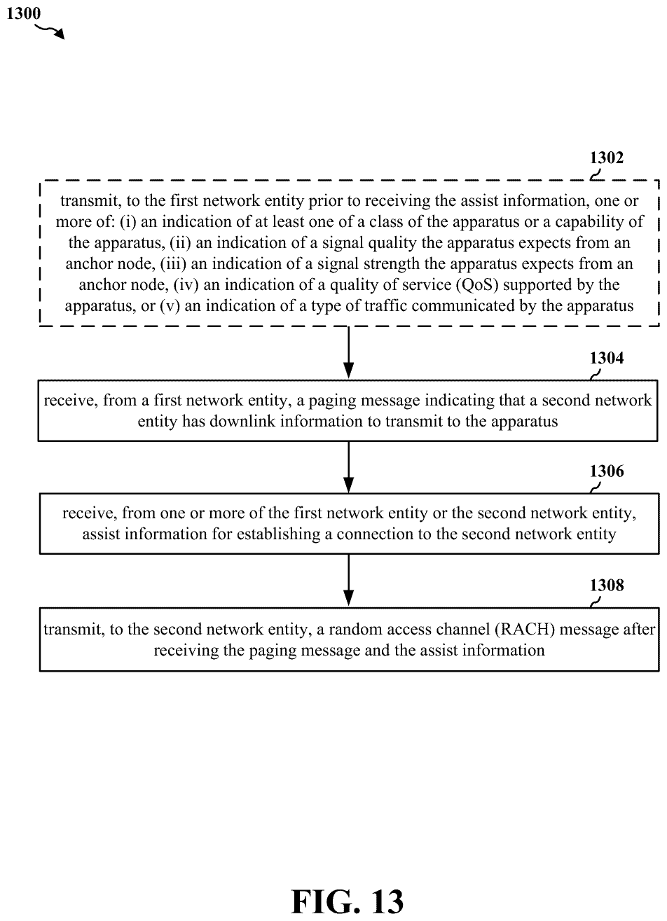

FIG. 13 is a flowchart 1300 of a method of wireless communication. The method may be performed by a UE (e.g., the UE 104; the apparatus 1402).

At 1302, the UE may optionally transmit, to the first network entity prior to receiving the assist information, one or more of: (i) an indication of at least one of a class of the apparatus or a capability of the apparatus, (ii) an indication of a signal quality the apparatus expects from an anchor node, (iii) an indication of a signal strength the apparatus expects from an anchor node, (iv) an indication of a quality of service (QOS) supported by the apparatus, or (v) an indication of a type of traffic communicated by the apparatus. For example, 1302 may be performed by a transmitting component 1440.

At 1304, the UE may receive, from a first network entity, a paging message indicating that a second network entity has downlink information to transmit to the apparatus. For example, 1304 may be performed by a receiving component 1442.

At 1306, the UE may receive, from one or more of the first network entity or the second network entity, assist information for establishing a connection to the second network entity. For example, 1306 may be performed by receiving component 1442.

At 1308, the UE may transmit, to the second network entity, a random access channel (RACH) message after receiving the paging message and the assist information. For example, 1308 may be performed by the transmitting component 1440.

In certain aspects, the assist information comprises system information (SI), and wherein the SI comprises a list of anchor cell identifiers (IDs) that the apparatus may use for camping.

In certain aspects, the SI further comprises an indication of whether one or more of the anchor cells associated with the list of anchor cell IDs support paging redirection to the second network entity.

In certain aspects, the SI further comprises an indication of an association between one or more of the anchor cells associated with the list of anchor cell IDs and a beam direction used by the second network entity.

In certain aspects, the assist information is received from the first network entity, and wherein the assist information comprises an indication of random access (RACH) resources used by the second network entity.

In certain aspects, the assist information is received from the first network entity, and wherein the assist information comprises one or more of an indication of transmit timing information of the second network entity, or an indication of a transmit power to be used by the apparatus for communication with the second network entity.

In certain aspects, the assist information is received from the first network entity, and wherein the assist information comprises an indication of whether the first network entity supports redirecting to the second network entity.

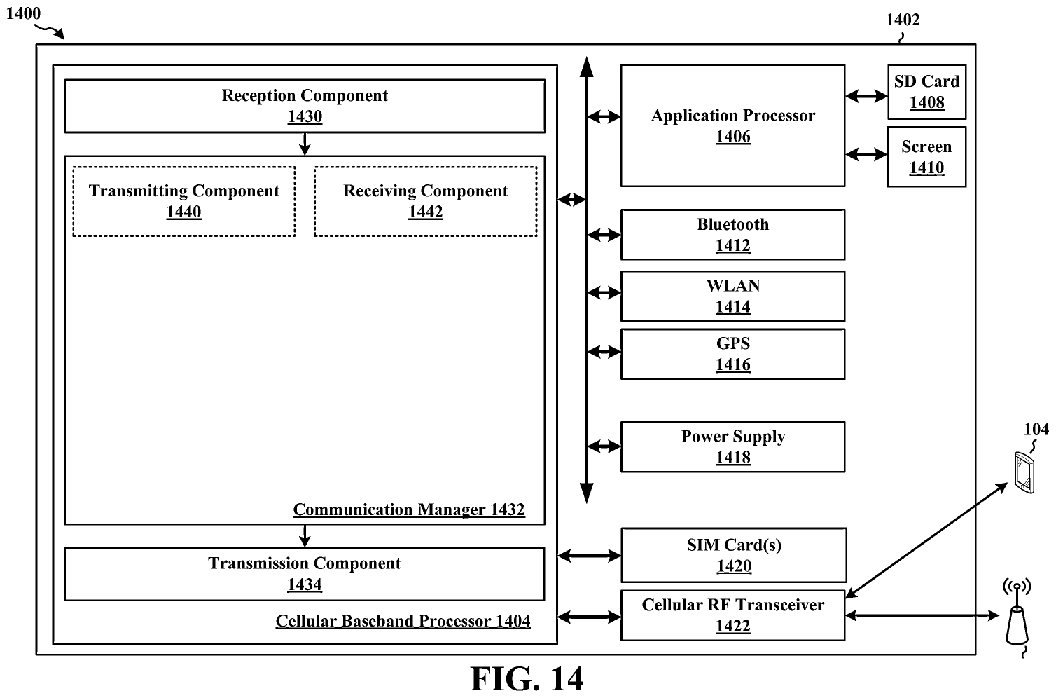

FIG. 14 is a diagram 1400 illustrating an example of a hardware implementation for an apparatus 1402. The apparatus 1402 is a UE and includes a cellular baseband processor 1404 (also referred to as a modem) coupled to a cellular RF transceiver 1422 and one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, and a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 104 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., see UE 104 of FIG. 3) and include the aforediscussed additional modules of the apparatus 1402.

In various examples, the apparatus 1402 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1432 includes a transmitting component 1440 that is configured to: transmit, to the first network entity prior to receiving the assist information, one or more of: (i) an indication of at least one of a class of the apparatus or a capability of the apparatus, (ii) an indication of a signal quality the apparatus expects from an anchor node, (iii) an indication of a signal strength the apparatus expects from an anchor node, (iv) an indication of a quality of service (QOS) supported by the apparatus, or (v) an indication of a type of traffic communicated by the apparatus; and transmit, to the second network entity, a random access channel (RACH) message after receiving the paging message and the assist information; e.g., as described in connection with 1302 and 1308.

The communication manager 1432 further includes a receiving component 1442 configured to: receive, from a first network entity, a paging message indicating that a second network entity has downlink information to transmit to the apparatus; and receive, from one or more of the first network entity or the second network entity, assist information for establishing a connection to the second network entity; e.g., as described in connection with 1304 and 1306.

The apparatus may include additional components that perform each of the blocks of the algorithm in the aforementioned flowchart of FIG. 13. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the cellular baseband processor 1404, includes means for transmitting, to the first network entity prior to receiving the assist information, one or more of: (i) an indication of at least one of a class of the apparatus or a capability of the apparatus, (ii) an indication of a signal quality the apparatus expects from an anchor node, (iii) an indication of a signal strength the apparatus expects from an anchor node, (iv) an indication of a quality of service (QOS) supported by the apparatus, or (v) an indication of a type of traffic communicated by the apparatus; means for receiving, from a first network entity, a paging message indicating that a second network entity has downlink information to transmit to the apparatus; means for receiving, from one or more of the first network entity or the second network entity, assist information for establishing a connection to the second network entity; and means for transmitting, to the second network entity, a random access channel (RACH) message after receiving the paging message and the assist information.

The aforementioned means may be one or more of the aforementioned components of the apparatus 1402 configured to perform the functions recited by the aforementioned means. As described supra, the apparatus 1402 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

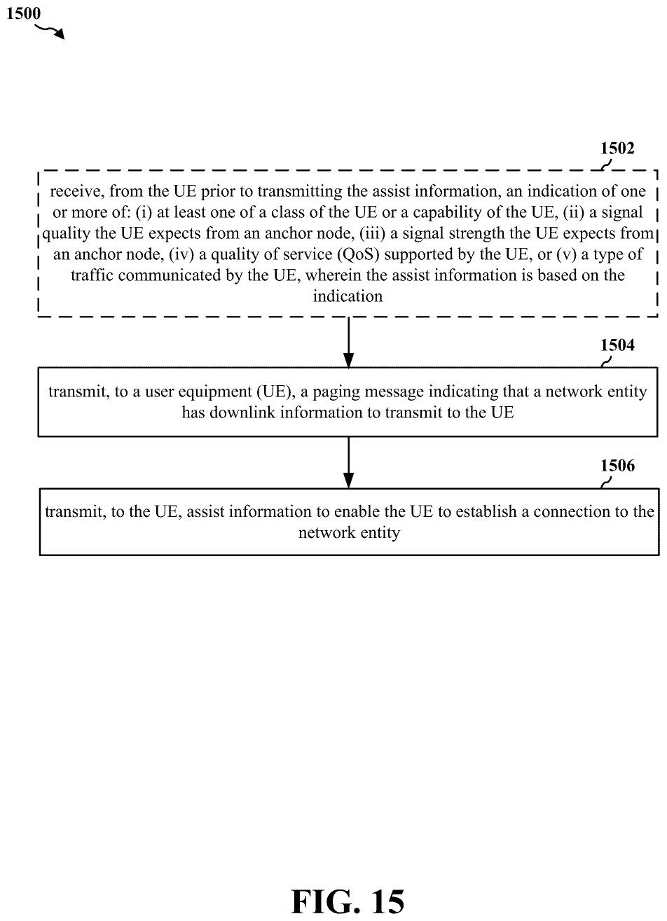

FIG. 15 is a flowchart 1500 of a method of wireless communication. The method may be performed by a base station (e.g., the base station 102/180; the apparatus 1602.

At 1502, the base station may optionally receive, from the UE prior to transmitting the assist information, an indication of one or more of: (i) at least one of a class of the UE or a capability of the UE, (ii) a signal quality the UE expects from an anchor node, (iii) a signal strength the UE expects from an anchor node, (iv) a quality of service (QoS) supported by the UE, or (v) a type of traffic communicated by the UE, wherein the assist information is based on the indication. For example, 1502 may be performed by receiving component 1640.

At 1504, the base station may transmit, to a user equipment (UE), a paging message indicating that a network entity has downlink information to transmit to the UE. For example, 1504 may be performed by a transmitting component 1642.

At 1506, the base station may transmit, to the UE, assist information to enable the UE to establish a connection to the network entity. For example, 1506 may be performed by a transmitting component 1642.

In certain aspects, the assist information comprises system information (SI), and wherein the SI comprises a list of anchor cell identifiers (IDs) that the apparatus may use for camping.

In certain aspects, the SI further comprises an indication of whether one or more of the anchor cells associated with the list of anchor cell IDs supports paging redirection to the network entity.

In certain aspects, the SI further comprises an indication of an association between one or more of the anchor cells associated with the list of anchor cell IDs and a beam direction used by the network entity.

In certain aspects, the assist information comprises an indication of random access (RACH) resources used by the network entity.

In certain aspects, the assist information comprises one or more of an indication of transmit timing information of the network entity, or an indication of a transmit power to be used by the UE for communication with the network entity.

In certain aspects, the assist information comprises an indication of whether the apparatus supports redirecting the UE to the network entity.

In certain aspects, wherein the assistance information is transmitted via the paging message.

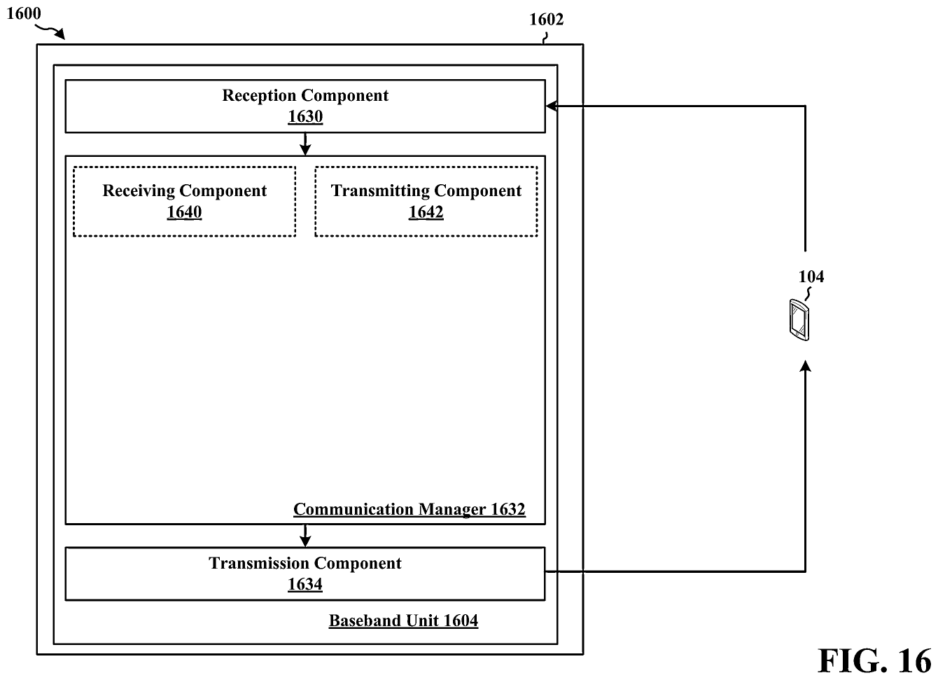

FIG. 16 is a diagram 1600 illustrating an example of a hardware implementation for an apparatus 1602. The apparatus 1602 is a BS and includes a baseband unit 1604. The baseband unit 1604 may communicate through a cellular RF transceiver with the UE 104. The baseband unit 1604 may include a computer-readable medium/memory. The baseband unit 1604 is responsible for general processing, including the execution of software stored on the computer-readable medium/memory. The software, when executed by the baseband unit 1604, causes the baseband unit 1604 to perform the various functions described supra. The computer-readable medium/memory may also be used for storing data that is manipulated by the baseband unit 1604 when executing software. The baseband unit 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the baseband unit 1604. The baseband unit 1604 may be a component of the BS 102/180 and may include the memory 376 and/or at least one of the TX processor 316, the RX processor 370, and the controller/processor 375.

In various examples, the apparatus 1602 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1632 includes a receiving component 1640 configured to receive, from the UE prior to transmitting the assist information, an indication of one or more of: (i) at least one of a class of the UE or a capability of the UE, (ii) a signal quality the UE expects from an anchor node, (iii) a signal strength the UE expects from an anchor node, (iv) a quality of service (QOS) supported by the UE, or (v) a type of traffic communicated by the UE, wherein the assist information is based on the indication; e.g., as described in connection with 1502.

The communication manager 1632 further includes a transmitting component 1642 configured to: transmit, to a user equipment (UE), a paging message indicating that a network entity has downlink information to transmit to the UE; and transmit, to the UE, assist information to enable the UE to establish a connection to the network entity; e.g., as described in connection with 1504 and 1506.

The apparatus may include additional components that perform each of the blocks of the algorithm in the aforementioned flowchart of FIG. 15. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the baseband unit 1604, includes means for receiving, from the UE prior to transmitting the assist information, an indication of one or more of: (i) at least one of a class of the UE or a capability of the UE, (ii) a signal quality the UE expects from an anchor node, (iii) a signal strength the UE expects from an anchor node, (iv) a quality of service (QOS) supported by the UE, or (v) a type of traffic communicated by the UE, wherein the assist information is based on the indication; means for transmitting, to a user equipment (UE), a paging message indicating that a network entity has downlink information to transmit to the UE; and transmitting, to the UE, assist information to enable the UE to establish a connection to the network entity.

The aforementioned means may be one or more of the aforementioned components of the apparatus 1602 configured to perform the functions recited by the aforementioned means. As described supra, the apparatus 1602 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

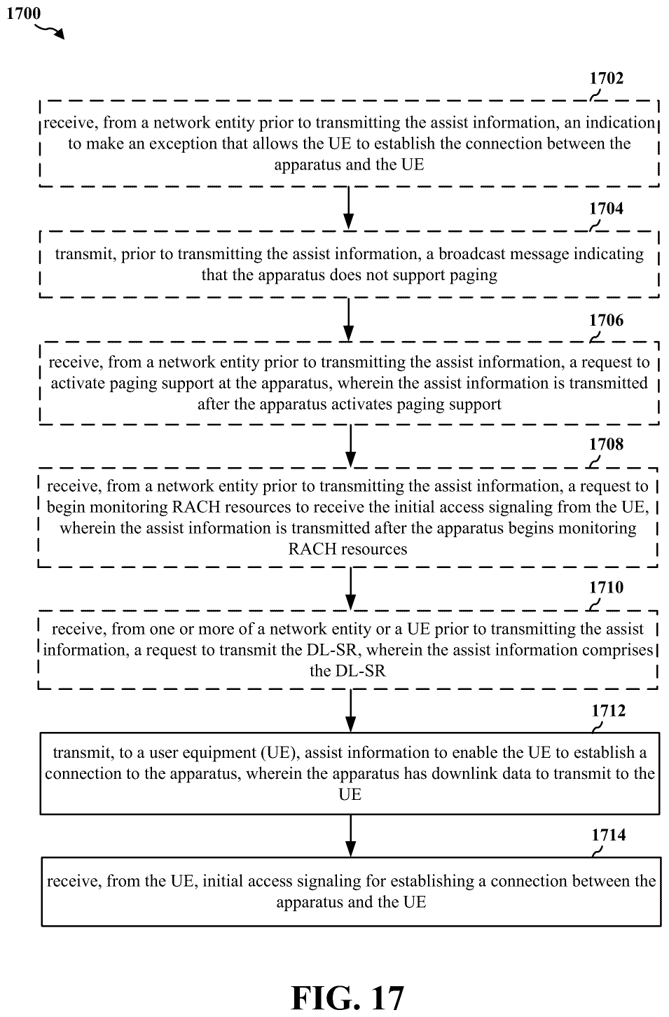

FIG. 17 is a flowchart 1700 of a method of wireless communication. The method may be performed by a base station (e.g., the base station 102/180; the apparatus 1802).

At 1702, the base station may optionally receive, from a network entity prior to transmitting the assist information, an indication to make an exception that allows the UE to establish the connection between the apparatus and the UE. For example, 1702 may be performed by a receiving component 1840.

At 1704, the base station may optionally transmit, prior to transmitting the assist information, a broadcast message indicating that the apparatus does not support paging. For example, 1704 may be performed by a transmitting component 1842.

At 1706, the base station may optionally receive, from a network entity prior to transmitting the assist information, a request to activate paging support at the apparatus, wherein the assist information is transmitted after the apparatus activates paging support. For example, 1706 may be performed by the transmitting component 1842.

At 1708, the base station may optionally receive, from a network entity prior to transmitting the assist information, a request to begin monitoring RACH resources to receive the initial access signaling from the UE, wherein the assist information is transmitted after the apparatus begins monitoring RACH resources. For example, 1708 may be performed by the receiving component 1840.

At 1710, the base station may optionally receive, from one or more of a network entity or a UE prior to transmitting the assist information, a request to transmit the DL-SR, wherein the assist information comprises the DL-SR. For example, 1710 may be performed by the receiving component 1840.

At 1712, the base station may transmit, to a user equipment (UE), assist information to enable the UE to establish a connection to the apparatus, wherein the apparatus has downlink data to transmit to the UE. For example, 1712 may be performed by the transmitting component 1842.

At 1714, the base station may receive, from the UE, initial access signaling for establishing a connection between the apparatus and the UE. For example, 1714 may be performed by the receiving component 1840.

In certain aspects, the apparatus is configured for network energy saving, and wherein the apparatus is configured to prevent the UE from establishing the connection between the apparatus and the UE based on UE capabilities and the network energy saving configuration.

In certain aspects, the apparatus is configured for network energy saving, and wherein the apparatus does not support paging based on the network energy saving configuration.

In certain aspects, the apparatus is configured for network energy saving, and wherein the apparatus does not monitor random access channel (RACH) resources based on the network energy saving configuration.

In certain aspects, the apparatus is configured for network energy saving, and wherein the apparatus does not transmit a downlink reference signal (DL-SR) based on the network energy saving configuration.

In certain aspects, the DL-SR comprises at least one of: a synchronization signal block (SSB), a light SSB, a channel state information reference signal (CSI-RS), or a tracking reference signal (TRS).

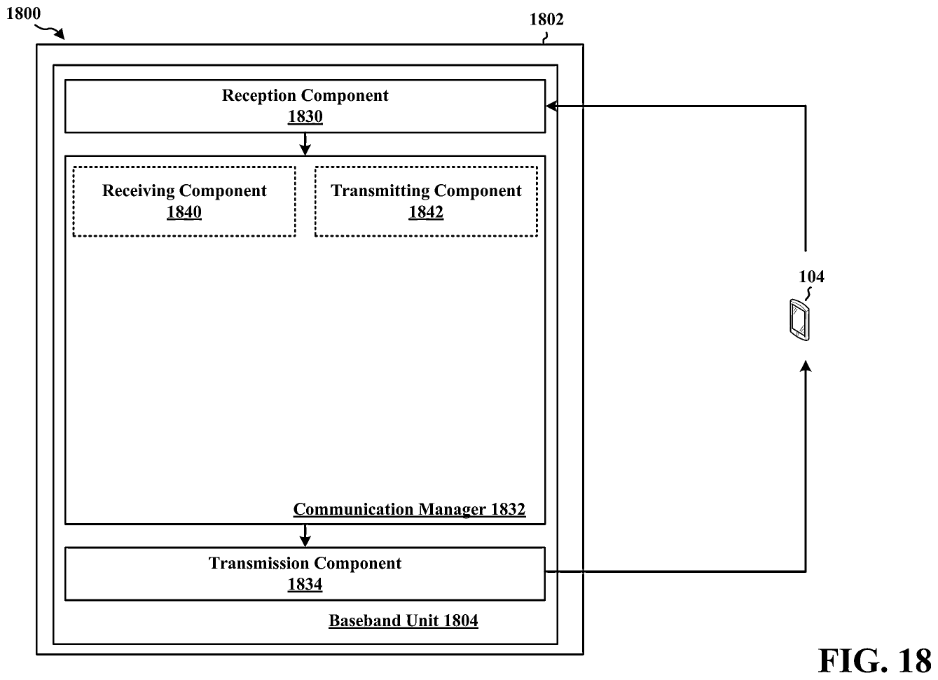

FIG. 18 is a diagram 1800 illustrating an example of a hardware implementation for an apparatus 1802. The apparatus 1802 is a BS and includes a baseband unit 1804. The baseband unit 1804 may communicate through a cellular RF transceiver with the UE 104. The baseband unit 1804 may include a computer-readable medium/memory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband unit 1804. The baseband unit 1804 may be a component of the BS 102/180 and may include the memory 376 and/or at least one of the TX processor 316, the RX processor 370, and the controller/processor 375.

In various examples, the apparatus 1802 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1832 includes a receiving component 1840 configured to: receive, from a network entity prior to transmitting the assist information, an indication to make an exception that allows the UE to establish the connection between the apparatus and the UE; receive, from a network entity prior to transmitting the assist information, a request to activate paging support at the apparatus, wherein the assist information is transmitted after the apparatus activates paging support; receive, from a network entity prior to transmitting the assist information, a request to begin monitoring RACH resources to receive the initial access signaling from the UE, wherein the assist information is transmitted after the apparatus begins monitoring RACH resources; receive, from one or more of a network entity or a UE prior to transmitting the assist information, a request to transmit the DL-SR, wherein the assist information comprises the DL-SR; and receive, from the UE, initial access signaling for establishing a connection between the apparatus and the UE; e.g., as described in connection with 1702, 1706, 1708, 1710, and 1714.

The communication manager 1832 further includes a transmitting component 1842 configured to: transmit, prior to transmitting the assist information, a broadcast message indicating that the apparatus does not support paging; and transmit, to a user equipment (UE), assist information to enable the UE to establish a connection to the apparatus, wherein the apparatus has downlink data to transmit to the UE; e.g., as described in connection with 1704 and 1712.

The apparatus may include additional components that perform each of the blocks of the algorithm in the aforementioned flowchart of FIG. 17. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the baseband unit 1804, includes: means for receiving, from a network entity prior to transmitting the assist information, an indication to make an exception that allows the UE to establish the connection between the apparatus and the UE; means for transmitting, prior to transmitting the assist information, a broadcast message indicating that the apparatus does not support paging; means for receiving, from a network entity prior to transmitting the assist information, a request to activate paging support at the apparatus, wherein the assist information is transmitted after the apparatus activates paging support; means for receiving, from a network entity prior to transmitting the assist information, a request to begin monitoring RACH resources to receive the initial access signaling from the UE, wherein the assist information is transmitted after the apparatus begins monitoring RACH resources; means for receiving, from one or more of a network entity or a UE prior to transmitting the assist information, a request to transmit the DL-SR, wherein the assist information comprises the DL-SR; means for transmitting, to a user equipment (UE), assist information to enable the UE to establish a connection to the apparatus, wherein the apparatus has downlink data to transmit to the UE; and means for receive, from the UE, initial access signaling for establishing a connection between the apparatus and the UE.

The aforementioned means may be one or more of the aforementioned components of the apparatus 1802 configured to perform the functions recited by the aforementioned means. As described supra, the apparatus 1802 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at a user equipment (UE), comprising: receiving, from a first network entity, assist information indicating resources via which a second network entity transmits a downlink reference signal (DL-RS); and receiving, from the second network entity, the DL-RS via the indicated resources.

Example 2 is the method of Example 1, wherein the DL-RS comprises at least one of a primary synchronization signal (PSS), a secondary synchronization signal (SSS), a channel state information reference signal (CSI-RS), or a tracking reference signal (TRS).

Example 3 is the method of any of Examples 1 and 2, further comprising: transmitting, to the first network entity, a request for the assist information prior to receiving the assist information.

Example 4 is the method of Example 3, wherein the UE is in an idle state or an inactive state with respect to the first network entity, and wherein the request comprises a RACH transmission, a scheduling request (SR) transmission, a physical uplink control channel (PUCCH) transmission, a physical uplink shared channel (PUSCH) transmission, or an uplink wake-up signal (UL-WUS) transmission.

Example 5 is the method of any of Examples 3 and 4, further comprising: receiving, from the first network entity, an indication of resources for transmitting the request for the assist information prior to receiving the assist information.

Example 6 is the method of any of Examples 1-5, wherein the indicated resources comprise an indication of one or more of a time resource, a frequency resource, or spatial resource used by the second network entity to transmit the DL-RS.

Example 7 is the method of any of Examples 1-6, further comprising: transmitting, to the first network entity, a report comprising information based on the received DL-RS.

Example 8 is the method of Example 7, wherein the assist information comprises a report configuration indicating information to be included in the report or a measurement to be included in the report, wherein the measurement is based on the received DL-RS.

Example 9 is the method of Example 8, wherein the report configuration further indicates one or more of: whether the UE is to include a full or partial identifier of the second network entity in the report, whether the UE is to include a full or partial beam index of the second network entity in the report, or whether the UE is to include full or partial timing information of the DL-RS received from the second network entity.

Example 10 is the method of Example 9, wherein, if the UE is to include partial timing information of the DL-RS received from the second network entity, the report configuration further indicates that the UE is to include the partial timing information in terms of a reference timing, or a delta offset value.

Example 11 is the method of any of Examples 7-10, further comprising: receiving, from the first network entity, a page signal indicating that the second network entity has a downlink transmission for the UE, wherein transmitting the report is in response to the page signal.

Example 12 is the method of any of Examples 7-11, further comprising: receiving, from the second network entity, additional information omitted from the DL-RS, wherein the additional information is received via the indicated resources after transmitting the report.

Example 13 is a method for wireless communication at an anchor cell, comprising: transmitting, to a user equipment (UE), assist information indicating resources via which a network entity transmits a downlink reference signal (DL-RS); and receiving, from the UE, a report comprising information associated with the DL-RS collected by the UE.

Example 14 is the method of Example 13, further comprising: receiving, from the UE, a request for the assist information prior to transmitting the assist information.

Example 15 is the method of Example 14, wherein the request comprises a RACH transmission, a scheduling request (SR) transmission, a physical uplink control channel (PUCCH) transmission, a physical uplink shared channel (PUSCH) transmission, or an uplink wake-up signal (UL-WUS) transmission.

Example 16 is the method of any of Examples 14 and 15, further comprising: transmitting, to the UE, an indication of resources for transmitting the request for the assist information prior to transmitting the assist information.

Example 17 is the method of any of Examples 13-16, wherein the indicated resources comprise an indication of one or more of a time resource, a frequency resource, or spatial resource used by the network entity to transmit the DL-RS.

Example 18 is the method of any of Examples 13-17, wherein the assist information comprises a report configuration indicating information to be included in the report or a measurement to be included in the report, wherein the measurement is based on the received DL-RS.

Example 19 is the method of any of Examples 13-18, further comprising: transmitting, to the network entity, information from the report received from the UE.

Example 20 is the method of Example 19, further comprising: receiving, from the network entity after transmitting the information from the report, an indication of one or more of: (i) whether the network entity will accept a connection with the UE, (ii) timing information network entity signaling, or (iii) resources to be shared with the UE for UE measurements.

Example 21 is the method of Example 20, further comprising: transmitting, to the UE, resources to be shared with the UE for UE measurements.

Example 22 is the method of any of examples Example 13-21, wherein the assist information comprises a beam-specific report configuration identifying one or more beams associated with at least one of the anchor cell or the network entity, and wherein the assist information further comprises an indication of a maximum number of beams for which the UE can include information in the beam-specific report.

Example 23 is a method for wireless communication at a network energy saving (NES) cell, comprising: transmitting a first downlink reference signal (DL-RS) comprising at least one of a primary synchronization signal (PSS), a secondary synchronization signal (SSS), a channel state information reference signal (CSI-RS), or a tracking reference signal (TRS); and receiving, from a network entity, signaling comprising information associated with the first DL-RS collected by a user equipment (UE).

Example 24 is the method of Example 23, wherein the first DL-RS is transmitted via a first beam, and wherein the method further comprises: transmitting, via a second beam having a different spatial direction relative to the first beam, a second DL-RS, wherein the signaling further comprises information associated with the second DL-RS collected by the UE.

Example 25 is the method of any of Examples 23 and 24, further comprising: transmitting, after receiving the signaling, at least one of: (i) a synchronization signal block (SSB), (ii) a master information block (MIB), (iii) a system information block (SIB), or (iv) at least one of: the PSS, the SSS, the CSI-RS, or the TRS omitted from the DL-RS.

Example 26 is the method of any of Examples 23-25, further comprising: begin, after receiving the signaling, monitoring a random access channel (RACH).

Example 27 is the method of any of Examples 23-26, further comprising: transmitting, to the network entity, signaling comprising an indication of resources used by the NES cell for transmission of another DL-RS and an indication of a measurement for the UE to perform using the resources.

Example 28 is the method of any of Examples 23-27, wherein the information associated with the first DL-RS is first information if the NES cell is part of a same distributed unit (DU) or central unit (CU) as the network entity, wherein the information associated with the first DL-RS is second information if the NES cell is part of a different DU or CU as the network entity, and wherein the first information is different from the second information.

Example 29 is a method for wireless communication at a user equipment (UE), comprising: receiving, from a first network entity, a paging message indicating that a second network entity has downlink information to transmit to the UE; receiving, from one or more of the first network entity or the second network entity, assist information for establishing a connection to the second network entity; and transmitting, to the second network entity, a random access channel (RACH) message after receiving the paging message and the assist information.

Example 30 is the method of Example 29, wherein the assist information comprises system information (SI), and wherein the SI comprises a list of anchor cell identifiers (IDs) that the UE may use for camping.

Example 31 is the method of Example 30, wherein the SI further comprises an indication of whether one or more of the anchor cells associated with the list of anchor cell IDs support paging redirection to the second network entity.

Example 32 is the method of any of Examples 30 and 31, wherein the SI further comprises an indication of an association between one or more of the anchor cells associated with the list of anchor cell IDs and a beam direction used by the second network entity.

Example 33 is the method of any of Examples 29-32, further comprising: transmitting, to the first network entity prior to receiving the assist information, one or more of: (i) an indication of at least one of a class of the UE or a capability of the UE, (ii) an indication of a signal quality the UE expects from an anchor node, (iii) an indication of a signal strength the UE expects from an anchor node, (iv) an indication of a quality of service (QOS) supported by the UE, or (v) an indication of a type of traffic communicated by the UE.

Example 34 is the method of any of Examples 29-33, wherein the assist information is received from the first network entity, and wherein the assist information comprises an indication of random access (RACH) resources used by the second network entity.

Example 35 is the method of any of Examples 29-34, wherein the assist information is received from the first network entity, and wherein the assist information comprises one or more of an indication of transmit timing information of the second network entity, or an indication of a transmit power to be used by the UE for communication with the second network entity.

Example 36 is the method of any of Examples 29-35, wherein the assist information is received from the first network entity, and wherein the assist information comprises an indication of whether the first network entity supports redirecting to the second network entity.

Example 37 is a method for wireless communication at an anchor cell, comprising: transmitting, to a user equipment (UE), a paging message indicating that a network entity has downlink information to transmit to the UE; and transmitting, to the UE, assist information to enable the UE to establish a connection to the network entity.

Example 38 is the method of Example 37, wherein the assist information comprises system information (SI), and wherein the SI comprises a list of anchor cell identifiers (IDs) that the UE may use for camping.

Example 39 is the method of Example 38, wherein the SI further comprises an indication of whether one or more of the anchor cells associated with the list of anchor cell IDs supports paging redirection to the network entity.

Example 40 is the method of any of Examples 38 and 39, wherein the SI further comprises an indication of an association between one or more of the anchor cells associated with the list of anchor cell IDs and a beam direction used by the network entity.

Example 41 is the method of any of Examples 37-40, further comprising: receiving, from the UE prior to transmitting the assist information, an indication of one or more of: (i) at least one of a class of the UE or a capability of the UE, (ii) a signal quality the UE expects from an anchor node, (iii) a signal strength the UE expects from an anchor node, (iv) a quality of service (QOS) supported by the UE, or (v) a type of traffic communicated by the UE, wherein the assist information is based on the indication.

Example 42 is the method of any of Examples 37-41, wherein the assist information comprises an indication of random access (RACH) resources used by the network entity.

Example 43 is the method of any of Examples claim 37-42, wherein the assist information comprises one or more of an indication of transmit timing information of the network entity, or an indication of a transmit power to be used by the UE for communication with the network entity.

Example 44 is the method of any of Examples 37-43, wherein the assist information comprises an indication of whether the anchor cell supports redirecting the UE to the network entity.

Example 45 is the method of any of Examples 37-44, wherein the assistance information is transmitted via the paging message.

Example 46 is a method for wireless communication at a network energy saving (NES) cell, comprising: transmitting, to a user equipment (UE), assist information to enable the UE to establish a connection to the NES cell, wherein the NES cell has downlink data to transmit to the UE; and receive, from the UE, initial access signaling for establishing a connection between the NES cell and the UE.

Example 47 is the method of Example 46, wherein the NES cell is configured to prevent the UE from establishing the connection between the NES cell and the UE based on UE capabilities and an NES configuration of the NES cell.

Example 48 is the method of Example 47, further comprising: receiving, from a network entity prior to transmitting the assist information, an indication to make an exception that allows the UE to establish the connection between the NES cell and the UE.

Example 49 is the method of any of Examples 46-48, wherein the NES cell does not support paging based on an NES configuration of the NES cell.

Example 50 is the method of Example 49, further comprising: transmit, prior to transmitting the assist information, a broadcast message indicating that the NES cell does not support paging.

Example 51 is the method of any of Examples 49 and 50, further comprising: receiving, from a network entity prior to transmitting the assist information, a request to activate paging support at the NES cell, wherein the assist information is transmitted after the NES cell activates paging support.

Example 52 is the method of any of Examples 46-51, wherein the NES cell does not monitor random access channel (RACH) resources based on an NES configuration of the NES cell.

Example 53 is the method of Example 52, further comprising: receiving, from a network entity prior to transmitting the assist information, a request to begin monitoring RACH resources to receive the initial access signaling from the UE, wherein the assist information is transmitted after the NES cell begins monitoring RACH resources.

Example 54 is the method of any of Examples 46-53, wherein the NES cell is configured for network energy saving, and wherein the NES cell does not transmit a downlink reference signal (DL-SR) based on the network energy saving configuration.

Example 55 is the method of Example 54, further comprising: receiving, from one or more of a network entity or a UE prior to transmitting the assist information, a request to transmit the DL-SR, wherein the assist information comprises the DL-SR.

Example 56 is the method of Example 55, wherein the DL-SR comprises at least one of: a synchronization signal block (SSB), a light SSB, a channel state information reference signal (CSI-RS), or a tracking reference signal (TRS).

Example 57 is a user equipment (UE) comprising: one or more memories, individually or in combination, having instructions; and one or more processors, individually or in combination, configured to execute the instructions and cause the UE to perform the method of any of Examples 1-12.

Example 58 is a user equipment (UE) comprising: one or more means for performing the method of any of Examples 1-12.

Example 59 is a non-transitory, computer-readable medium comprising computer executable code, the code when executed by one or more processors causes the one or more processors to, individually or in combination, perform the method of any of Examples 1-18 for wireless communication by a user equipment (UE).

Example 60 is an anchor cell comprising: one or more memories, individually or in combination, having instructions; and one or more processors, individually or in combination, configured to execute the instructions and cause the anchor cell to perform the method of any of Examples 13-22.

Example 61 is an anchor cell comprising: one or more means for performing the method of any of Examples 13-22.

Example 62 is a non-transitory, computer-readable medium comprising computer executable code, the code when executed by one or more processors causes the one or more processors to, individually or in combination, perform the method of any of Examples 13-22 for wireless communication by an anchor cell.

Example 63 is an NES cell comprising: one or more memories, individually or in combination, having instructions; and one or more processors, individually or in combination, configured to execute the instructions and cause the NES cell to perform the method of any of Examples 23-28.

Example 64 is an NES cell comprising: one or more means for performing the method of any of Examples 23-28.

Example 65 is a non-transitory, computer-readable medium comprising computer executable code, the code when executed by one or more processors causes the one or more processors to, individually or in combination, perform the method of any of Examples 23-28 for wireless communication by an NES cell.

Example 66 is a user equipment (UE) comprising: one or more memories, individually or in combination, having instructions; and one or more processors, individually or in combination, configured to execute the instructions and cause the UE to perform the method of any of Examples 29-36.

Example 67 is a user equipment (UE) comprising: one or more means for performing the method of any of Examples 29-36.

Example 68 is a non-transitory, computer-readable medium comprising computer executable code, the code when executed by one or more processors causes the one or more processors to, individually or in combination, perform the method of any of Examples 29-36 for wireless communication by a user equipment (UE).

Example 69 is an anchor cell comprising: one or more memories, individually or in combination, having instructions; and one or more processors, individually or in combination, configured to execute the instructions and cause the anchor cell to perform the method of any of Examples 37-45.

Example 70 is an anchor cell comprising: one or more means for performing the method of any of Examples 37-45.

Example 71 is a non-transitory, computer-readable medium comprising computer executable code, the code when executed by one or more processors causes the one or more processors to, individually or in combination, perform the method of any of Examples 37-45 for wireless communication by an anchor cell.

Example 72 is an NES cell comprising: one or more memories, individually or in combination, having instructions; and one or more processors, individually or in combination, configured to execute the instructions and cause the NES cell to perform the method of any of Examples 46-56.

Example 73 is an NES cell comprising: one or more means for performing the method of any of Examples 46-56.

Example 74 is a non-transitory, computer-readable medium comprising computer executable code, the code when executed by one or more processors causes the one or more processors to, individually or in combination, perform the method of any of Examples 46-56 for wireless communication by an NES cell.

What is claimed is:

1. An apparatus for wireless communication, comprising:
one or more memories, individually or in combination, having instructions; and
one or more processors, individually or in combination, configured to execute the instructions and cause the apparatus to:
receive, from a first network entity, assist information indicating resources via which a second network entity transmits a downlink reference signal (DL-RS); and
receive, from the second network entity, the DL-RS via the indicated resources.

2. The apparatus of claim 1, wherein the DL-RS comprises at least one of a primary synchronization signal (PSS), a secondary synchronization signal (SSS), a channel state information reference signal (CSI-RS), or a tracking reference signal (TRS).

3. The apparatus of claim 1, wherein the one or more processors, individually or in combination, are further configured to cause the apparatus to:
transmit, to the first network entity, a request for the assist information prior to receiving the assist information.

4. The apparatus of claim 3, wherein the apparatus is in an idle state or an inactive state with respect to the first network entity, and wherein the request comprises a RACH transmission, a scheduling request (SR) transmission, a physical uplink control channel (PUCCH) transmission, a physical uplink shared channel (PUSCH) transmission, or an uplink wake-up signal (UL-WUS) transmission.

5. The apparatus of claim 3, wherein the one or more processors, individually or in combination, are further configured to cause the apparatus to:
receive, from the first network entity, an indication of resources for transmitting the request for the assist information prior to receiving the assist information.

6. The apparatus of claim 1, wherein the indicated resources comprise an indication of one or more of a time resource, a frequency resource, or spatial resource used by the second network entity to transmit the DL-RS.

7. The apparatus of claim 1, wherein the apparatus is in a connected state with respect to the first network entity, and wherein the one or more processors, individually or in combination, are further configured to cause the apparatus to:
transmit, to the first network entity, a report comprising information based on the received DL-RS.

8. The apparatus of claim 7, wherein the assist information comprises a report configuration indicating information to be included in the report or a measurement to be included in the report, wherein the measurement is based on the received DL-RS.

9. The apparatus of claim 8, wherein the report configuration further indicates one or more of:
whether the apparatus is to include a full or partial identifier of the second network entity in the report,
whether the apparatus is to include a full or partial beam index of the second network entity in the report, or
whether the apparatus is to include full or partial timing information of the DL-RS received from the second network entity.

10. The apparatus of claim 9, wherein, if the apparatus is to include partial timing information of the DL-RS received from the second network entity, the report configuration further indicates that the apparatus is to include the partial timing information in terms of a reference timing, or a delta offset value.

11. The apparatus of claim 7, wherein the one or more processors, individually or in combination, are further configured to cause the apparatus to:
receive, from the first network entity, a page signal indicating that the second network entity has a downlink transmission for the apparatus, wherein transmitting the report is in response to the page signal.

12. The apparatus of claim 7, wherein the one or more processors, individually or in combination, are further configured to cause the apparatus to:
receive, from the second network entity, additional information omitted from the DL-RS, wherein the additional information is received via the indicated resources after transmitting the report.

13. An apparatus for wireless communication, comprising:
one or more memories, individually or in combination, having instructions; and
one or more processors, individually or in combination, configured to execute the instructions and cause the apparatus to:
transmit, to a user equipment (UE), assist information indicating resources via which a network entity transmits a downlink reference signal (DL-RS); and
receive, from the UE, a report comprising information associated with the DL-RS collected by the UE.

14. The apparatus of claim 13, wherein the one or more processors, individually or in combination, are further configured to cause the apparatus to:
receive, from the UE, a request for the assist information prior to transmitting the assist information.

15. The apparatus of claim 14, wherein the request comprises a RACH transmission, a scheduling request (SR) transmission, a physical uplink control channel (PUCCH) transmission, a physical uplink shared channel (PUSCH) transmission, or an uplink wake-up signal (UL-WUS) transmission.

16. The apparatus of claim 14, wherein the one or more processors, individually or in combination, are further configured to cause the apparatus to:
transmit, to the UE, an indication of resources for transmitting the request for the assist information prior to transmitting the assist information.

17. The apparatus of claim 13, wherein the indicated resources comprise an indication of one or more of a time resource, a frequency resource, or spatial resource used by the network entity to transmit the DL-RS.

18. The apparatus of claim 13, wherein the assist information comprises a report configuration indicating information to be included in the report or a measurement to be included in the report, wherein the measurement is based on the received DL-RS.

19. The apparatus of claim 13, wherein the one or more processors, individually or in combination, are further configured to cause the apparatus to:
transmit, to the network entity, information from the report received from the UE.

20. The apparatus of claim 19, wherein the one or more processors, individually or in combination, are further configured to cause the apparatus to:
receive, from the network entity after transmitting the information from the report, an indication of one or more of: (i) whether the network entity will accept a connection with the UE, (ii) timing information network entity signaling, or (iii) resources to be shared with the UE for UE measurements.

21. The apparatus of claim 20, wherein the one or more processors, individually or in combination, are further configured to cause the apparatus to:
transmit, to the UE, resources to be shared with the UE for UE measurements.

22. The apparatus of claim 13, wherein the assist information comprises a beam-specific report configuration identifying one or more beams associated with at least one of the apparatus or the network entity, and wherein the assist information further comprises an indication of a maximum number of beams for which the UE can include information in the beam-specific report.

23. An apparatus for wireless communication, comprising:
one or more memories, individually or in combination, having instructions; and
one or more processors, individually or in combination, configured to execute the instructions and cause the apparatus to:
receive, from a first network entity, a paging message indicating that a second network entity has downlink information to transmit to the apparatus;
receive, from one or more of the first network entity or the second network entity, assist information for establishing a connection to the second network entity; and
transmit, to the second network entity, a random access channel (RACH) message after receiving the paging message and the assist information.

24. The apparatus of claim 23, wherein the assist information comprises system information (SI), and wherein the SI comprises a list of anchor cell identifiers (IDs) that the apparatus may use for camping.

25. The apparatus of claim 24, wherein the SI further comprises an indication of whether one or more of the anchor cells associated with the list of anchor cell IDs support paging redirection to the second network entity.

26. The apparatus of claim 24, wherein the SI further comprises an indication of an association between one or more of the anchor cells associated with the list of anchor cell IDs and a beam direction used by the second network entity.

27. The apparatus of claim 26, wherein the one or more processors, individually or in combination, are further configured to execute the instructions and cause the apparatus to:
transmit, to the first network entity prior to receiving the assist information, one or more of: (i) an indication of at least one of a class of the apparatus or a capability of the apparatus, (ii) an indication of a signal quality the apparatus expects from an anchor node, (iii) an indication of a signal strength the apparatus expects from an anchor node, (iv) an indication of a quality of service (QOS) supported by the apparatus, or (v) an indication of a type of traffic communicated by the apparatus.

28. An apparatus for wireless communication, comprising:
one or more memories, individually or in combination, having instructions; and
one or more processors, individually or in combination, configured to execute the instructions and cause the apparatus to:
transmit, to a user equipment (UE), a paging message indicating that a network entity has downlink information to transmit to the UE; and
transmit, to the UE, assist information to enable the UE to establish a connection to the network entity.

29. The apparatus of claim 28, wherein the assist information comprises system information (SI), and wherein the SI comprises a list of anchor cell identifiers (IDs) that the UE may use for camping.

30. The apparatus of claim 29, wherein the SI further comprises an indication of whether one or more of the anchor cells associated with the list of anchor cell IDs supports paging redirection to the network entity.
